(19) United States
(12) Patent Application Publication
(10) Pub. No.: US 2013/0282442 A1
(43) Pub. Date: Oct. 24, 2013

(54) SYSTEM AND METHOD FOR CUSTOMER VALUE CREATION

(71) Applicant: Valkre Solutions, Inc., (US)

(72) Inventors: JERRY ALDERMAN, Saint Charles, IL (US); Brian Kiep, Barrington, IL (US)

(73) Assignee: Valkre Solutions, Inc., Chicago, IL (US)

(21) Appl. No.: 13/836,144

(22) Filed: Mar. 15, 2013

Related U.S. Application Data
(63) Continuation-in-part of application No. 13/674,650, filed on Nov. 12, 2012.
Application No. 13/674,650 is a continuation of application No. 12/486,700, filed on Jun. 17, 2009, now Pat. No. 8,311,879.
(60) Provisional application No. 61/073,293, filed on Jun. 17, 2008.
(60) Provisional application No. 61/187,372, filed on Jun. 16, 2009.

(51) Int. Cl. G06Q 10/06

(52) U.S. Cl. CPC G06Q 10/0637; G06Q 30/0201
USPC 705/7.36

(57) ABSTRACT

A method and system for managing customer value creation may include receiving a dataset about a customer organization having value attributes with a relative numerical percentage score and a value; processing the dataset to generate a quantified economic or financial impact on a profitability of the customer organization based on the value attributes; generating a customer data collection template based on the quantified economic or financial impact for use in obtaining information from the customer organization; receiving another dataset about the customer organization based on information provided by the customer organization, the other dataset including value attributes having a relative numerical percentage score and a value; processing at least the other dataset to generate another quantified economic or financial impact on the profitability of the customer organization based on the value attributes; identifying one or more investment opportunities based on the another quantified economic or financial impact on the profitability of the customer organization; and generating and prioritizing one or more initiatives to achieve the identified investment opportunities to increase the profitability of the customer organization.

### CROSS REFERENCE TO RELATED APPLICATIONS

This application is a continuation-in-part of U.S. patent application Ser. No. 13/674,650, filed Nov. 12, 2012, which is a continuation of U.S. patent application Ser. No. 12/486,700, filed Jun. 17, 2009, now U.S. Pat. No. 8,311,879, issued Nov. 13, 2012. U.S. application Ser. No. 12/486,700 claims the priority benefit of U.S. Provisional Patent Application No. 61/187,372, filed Jun. 16, 2009, and U.S. Provisional Patent Application No. 61/073,293, filed Jun. 17, 2008. Each of the aforementioned applications is incorporated herein by reference in its entirety for all purposes.

### TECHNICAL FIELD

The present invention relates to a system and method for data collection, analysis and management.

### BACKGROUND OF THE INVENTION

Companies have long made strategic and investment decisions by investing in the collection and analysis of internal data streams. Typical internal data streams, such as those seen in a normal customer relationship management system, include customer order history, customer service history, sales forecasts, marketing campaign results, and supply chain/operating data. The fundamental use of this data is to measure an organization's profitability with a customer or set of customers.

While this type of data is commercially focused, and has been sufficient in the past, in today's markets this type of knowledge is simply the cost of doing business. As competition intensifies with the introduction of so much readily available information, the ability for organizations to differentiate will become more difficult. In today's markets, an organization's ability to differentiate will require a deep understanding of how their investments and strategies impact their bottom line as well as their customer's bottom line. Data streams that are internally-focused on the economics of the company, not on the economics of the company's customers, are missing an entire dimension when evaluating their competitiveness. Organizations that can add data streams in a systemic fashion along the dimension of understanding their role in a customer's profitability will be able to align their investments and strategies around the economics of their customers, not their own, and succeed in the future.

In recent years the market has seen an influx of “Voice of Customer” firms and methodologies that use surveys to collect customer information to better understand their services. This type of data is typically collected during single-focus projects, and creates silos of data that are not easily integrated into the organization, acted upon, and measured on an ongoing and systemic basis. In addition, existing ‘Voice of Customer’ firms and methodologies focus on qualitative and relative indices such as customer satisfaction or preference that is inherently difficult to quantify the economic benefit a customer receives as a result of an organization's investments or strategies. Finally, existing ‘Voice of Customer’ firms and methodologies are built for the execution by advanced degree subject matter experts, in turn creating a dependency on these high cost individuals for the data stream.

### SUMMARY OF INVENTION

In several exemplary embodiments, the system of the present invention may be used by a consulting business helping a client (i.e., the organization) collect, manage, analyze and act on data (i.e., manage “customer value creation” or “CVC”) from the client's customers. The system may be used by organizations without depending on consultants to manage customer value creation. In one embodiment, at the core of managing customer value creation is an integrated dataset and schema, termed “Customer Value Creation Data.” Embodiments of the present invention go beyond “Voice of Customer” work in that customer value creation includes a computer-assisted or implemented process, software, and education to create a sustainable and scalable platform for profitable growth.

In one embodiment, the system comprises a CVC Dataset, which is an integrated schema of, at the highest level, three data types: Differential Value Proposition; Demand Influence; and Opportunities. At the highest level, the two key differentiators are the dataset and how the data integrates to form a system of understanding customer value creation. Each individual piece of the dataset is collected to better understand how organizations impact their customer's profitability so that these organizations better know where to invest to create a differential competitive advantage.

Differential Value Proposition is the ability of the organization's products and services to positively impact their customer's bottom line relative to the organization's competitors. The ability to create a DVP can be correlated to the investments and strategies made by the organization on an ongoing basis. The connection between an organization's investments and strategies, and their customer's bottom line, comprises three parts: the investments and strategies that an organization makes (Value Attributes); the relative importance or impact each investment or strategy has on a customer's bottom line (Value Attribute Scores); and the combined, quantified economic or financial impact that all the Value Attributes have on a customer's bottom line or profitability (Differential Value Proposition Percentage, or “DVP %”). The Differential Value Proposition may be measured in three stages: internally to create a baseline understanding; currently from the customer's perspective; and the customer's perspective on what the Differential Value Proposition can be.

The Demand Influence element comprises measuring market and channel influence to provide insight into where a Differential Value Proposition is critical. In one embodiment, it comprises a map of investment options within a given market, organization or channel that instructs an organization where a Differential Value Proposition % needs to be strong and where the investments to create a Differential Value Proposition should be focused. A Demand Influence Map may comprise three parts: which constituents in a given market, organization, or channel control demand for an organization's products or solutions currently; how the demand control will change in the future; and based on that information, where should the investment focus be placed.

The Opportunities element comprises the identification of opportunities to create incremental value for a customer. One approach comprises examining and explaining the difference between current DVPs and goal DVPs. Examples of opportunities and their impacts include: (a) improving special order sales lead times, with the impact of freeing working capital and increasing the number of customers; (b) promoting use of recycled content for “green” products, with the impact of increasing the number of customers; and (c) and becoming more responsive to day-to-day needs, with the impact of reducing operating costs.

An investment detail may comprise two parts: specification of how an organization should invest to create differential value, and how that investment will impact a customer's profitability.

By combining individual pieces and Customer Value Creation data types, silos of information are turned into a system of knowledge. This system of knowledge provides the basis for managing the dataset above and beyond simplistic analysis. At the highest level, when two of the three data types are combined, a piece of the CVC data system is created. These are Value Creation Opportunities, Channel Understanding, and Probability of Success.

In another exemplary embodiment, the system comprises the CVC Approach, which comprises the following modules or components: Gather/Discover, Analyze, Execute, Measure, and Certify. These modules, when combined, are the framework for managing customer value from an outside-in (i.e., customer-driven) perspective. By doing so, organizations create a competitive advantage by continuously optimizing return on investments made and eliminating the investments that are bound to fail. In the description of the CVC approach that follows, the CVC solution focuses on transforming the way client organizations create, deliver, and measure customer value, using a rigorous, quantitative approach.

In one embodiment, the CVC Approach comprises a computer program that implements the above modules in the appropriate order, collects and stores relevant data, and perform necessary calculations. The program may be run through an Internet web browser.

In an embodiment, a method and system for managing customer value creation may be provided including receiving a first dataset about a customer organization, the first dataset comprising first value attributes each having a relative numerical percentage score and a value; processing the first dataset to generate a first quantified economic or financial impact on a profitability of the customer organization based on the first value attributes; generating one or more customer data collection templates based on the first quantified economic or financial impact on a profitability of the customer organization for use in obtaining information from the customer organization; receiving a second dataset about the customer organization based on the information provided by the customer organization, the second dataset comprising second value attributes each having a relative numerical percentage score and a value; processing at least the second dataset to generate a second quantified economic or financial impact on the profitability of the customer organization based on the second value attributes; identifying one or more investment opportunities based on the second quantified economic or financial impact on the profitability of the customer organization; and generating and prioritizing one or more initiatives to achieve the identified investment opportunities to increase the profitability of the customer organization.

In an embodiment, the processing the first dataset may comprise generating a qualitative scale having labeled increments depicting the first quantified economic or financial impact on a profitability of the customer organization based on the first value attributes.

In an embodiment, the generated one or more customer data collection templates may include the qualitative scale based on the first quantified economic or financial impact on the profitability of the customer organization for use in obtaining information from the customer organization.

In an embodiment, the receiving the second dataset about the customer organization may include input from the customer based on the qualitative scale.

In an embodiment, the receiving the second dataset about the customer organization may include receiving a ranking associated with each of the second value attributes from the customer and converting the ranking of each of the second value attributes to the relative numerical percentage score.

In an embodiment, the method may include aggregating the processed second datasets from a plurality of customer organizations; grouping similar second value attributes from the processed second datasets; and ranking the grouped similar second value attributes based on total value. The processing at least the second dataset may comprise providing a user interface listing unprocessed items from the aggregated second datasets from a plurality of customer organizations, which interface may include a drag-and-drop capability for the grouping of the similar second value attributes; and utilizing search analytics to perform batch processing of the unprocessed items from the aggregated second datasets from a plurality of customer organizations.

In an embodiment, the method may include providing a selectable option to allow a user to manually identify one or more investment opportunities.

In an embodiment, the method may include merging the first and second datasets; and assembling a list of the one or more generated and prioritized initiatives that have been completed.

### BRIEF DESCRIPTION OF THE DRAWINGS

FIG. 1 is a diagram showing components of the Customer Value Creation Dataset in accordance with an exemplary embodiment of the present invention.

FIG. 2 is an exemplary diagram showing measuring channel influence under the Demand Influence component.

FIG. 3 is an exemplary diagram showing the examination of current and goal DVPs under the Opportunities component.

FIG. 4 is an exemplary diagram summarizing Value Creation Opportunities.

FIG. 5 is an exemplary diagram comparing Demand Influence with DVP %.

FIG. 6 shows the components or modules of the CVC Approach, in accordance with an exemplary embodiment of the present invention.

FIG. 7 shows an exemplary Internal Hypothesis screen for the Gather module.

FIG. 8 shows another exemplary Internal Hypothesis screen for the Gather module.

FIG. 9 shows another exemplary Internal Hypothesis screen for the Gather module.

FIG. 10 shows an exemplary Internal Hypothesis screen for anchoring for the Gather module.

FIG. 11 shows another exemplary Internal Hypothesis screen for anchoring for the Gather module.

FIG. 12 shows another exemplary Internal Hypothesis screen for anchoring for the Gather module.

FIG. 13 shows another exemplary Internal Hypothesis screen for the Gather module.

FIG. 14 shows a Channel Influence data collection template for the Gather module.

FIG. 15 shows a DVP data collection template for the Gather module.

FIG. 16 shows an Interview Capture Screen for the Gather module.

FIG. 17 shows an Influence Capture Screen for the Gather module.

FIG. 18 shows a DVP Capture Screen for the Gather module.

FIG. 19 shows an Opportunity Capture Screen for the Gather module.

FIG. 20 shows an exemplary graphical comparison of dataset perspectives for the Analyze module.

FIG. 21 is an exemplary diagram comparing Demand Influence with DVP %.

FIG. 22 is a table of scenarios based on DVP and Demand Influence for the Analyze module.

FIG. 23 shows a setup for Value Segmentation Criteria for the Analyze module.

FIGS. 24A-24B show exemplary Value Segmentation Analysis comparisons for the Analyze module.

FIGS. 25A-25B show exemplary Value Segmentation Analysis comparisons for the Analyze module.

FIG. 26 shows a Value Attribute Segmentation Report for the Analyze module.

FIG. 27 shows an Opportunity Analysis chart for the Analyze module.

FIG. 28 shows an Opportunity Analysis screen for the Analyze module.

FIG. 29 shows another Opportunity Analysis screen for the Analyze module.

FIG. 30 shows an Opportunity Analysis list of initiatives for the Analyze module.

FIG. 31 shows an exemplary Value Capture Analysis graph for the Analyze module.

FIG. 32 shows a Value Capture Analysis chart for the Analyze module.

FIG. 33 shows a Value Capture Analysis exchange factor chart for the Analyze module.

FIG. 34 shows a Value Capture Analysis risk factor chart for the Analyze module.

FIG. 35 shows a Value Capture Analysis investment screen for the Analyze module.

FIG. 36 shows a Value Creation Plan integrated data schema for the Execute module.

FIG. 37 shows a Value Creation Plan customer needs quantification screen for the Execute module.

FIG. 38 shows a Value Creation Plan initiatives status screen for the Execute module.

FIG. 39 shows a Value Capture chart for the Execute module.

FIG. 40 shows a Value Creation Plan forecast screen for the Execute module.

FIG. 41 shows an Initiative chart for the Execute module.

FIG. 42 shows an Initiative Management chart for the Execute module.

FIG. 43 shows an Action Execution screen for the Execute module.

FIG. 44 shows a Process Integration chart for the Execute module.

FIG. 45 shows an Execution Dashboard for the Measure module.

FIGS. 46a-46B show exemplary DVP collection screens for the Measure module.

FIG. 47 shows an exemplary Value Creation Progress screen for the Measure module.

FIG. 48 shows another exemplary Value Creation Progress screen for the Measure module.

FIGS. 49A-49B show exemplary Value Creation Dashboards for the Measure module.

FIG. 50 shows a Value Capture Dashboard for the Measure module.

FIG. 51 shows an Online Course screen for the Integrated Education Platform component of the Certify module.

FIG. 52 shows a Roles & Responsibilities table for the Certify module.

FIG. 53 shows an exemplary CVC Adoption Progress chart for the Certify module.

FIG. 54 shows a Change Management chart for the Certify module.

FIG. 55 shows a Change Management milestone chart for the Certify module.

FIG. 56 is a diagram showing the Customer Value Creation Product Suite in accordance with another exemplary embodiment of the present invention.

FIGS. 57A, 57B, 58A, 58B, 59A, 59B, 60A, 60B, 61, and 62 show steps in an embodiment of the Discovery Process of the Product Suite.

FIG. 63 is a chart of the Render Data Schema Design.

FIG. 64 shows an exemplary embodiment of the Render application design.

FIG. 65 shows an exemplary screen from Render showing a Channel Influence Report.

FIG. 66 shows an Application Shell client value form.

FIG. 67 shows a class catalog matrix.

FIG. 68 shows an exemplary tool tips screen.

FIG. 69 depicts an illustrative screenshot of an internal DVP calculation including generation of a qualitative scale in accordance with another embodiment of the invention in the Gather/Discover module.

FIG. 70A depicts an exemplary screenshot of a simplified qualitative Interview Guide or template generated and completed in accordance with another embodiment of the invention in the Gather/Discover module.

FIG. 70B depicts an exemplary flow chart illustrating an algorithm for converting a ranked list of Value Attributes into inferred scores for the Value Attributes as shown in FIG. 70A in accordance with an embodiment of the invention in the Gather/Discover module.

FIG. 71 depicts an Interview Guide template including the qualitative DVP % scale of FIG. 69 in accordance with another embodiment of the invention in the Gather/Discover module.

FIG. 72 depicts an exemplary screenshot showing an aggregation of comments from many customers and utilizing the aggregated comments to identify and rank primary differentiators of the organization in accordance with another embodiment of the invention in the Analysis module.

FIG. 73 depicts an exemplary screenshot showing a selectable option for allowing data entry of an identified opportunity in accordance with another embodiment of the invention in the Analysis module.

FIG. 74 depicts a flow chart illustrating a process for combining the aggregated differentiators identified and grouped in FIG. 72 with completed initiatives in accordance with another embodiment of the invention in the Analysis or Execute modules.

FIG. 75 depicts an exemplary screenshot depicting a system for processing qualitative customer comments in accordance with another embodiment of the invention in the Analysis module.

### DETAILED DESCRIPTION

The system and method of the present invention is a methodology and tool set that allows organizations to collect, manage, analyze, and act on data that quantifies their competitive advantage from their customer's perspective. This is done by enabling organizations to systemically answer the question, “Do My Customers make more money doing business with me?”

In one exemplary embodiment, the system of the present invention may be used by a consulting business helping a client (i.e., the organization) collect, manage, analyze and act on data (i.e., manage “customer value creation” or “CVC”) from the client's customers. The system may be used by organizations without depending on consultants to manage customer value creation. In one embodiment, at the core of managing customer value creation is an integrated dataset and schema, termed “Customer Value Creation Data.” Embodiments of the present invention go beyond “Voice of Customer” work in that customer value creation includes a computer-assisted or implemented process, software, and education to create a sustainable and scalable platform for profitable growth.

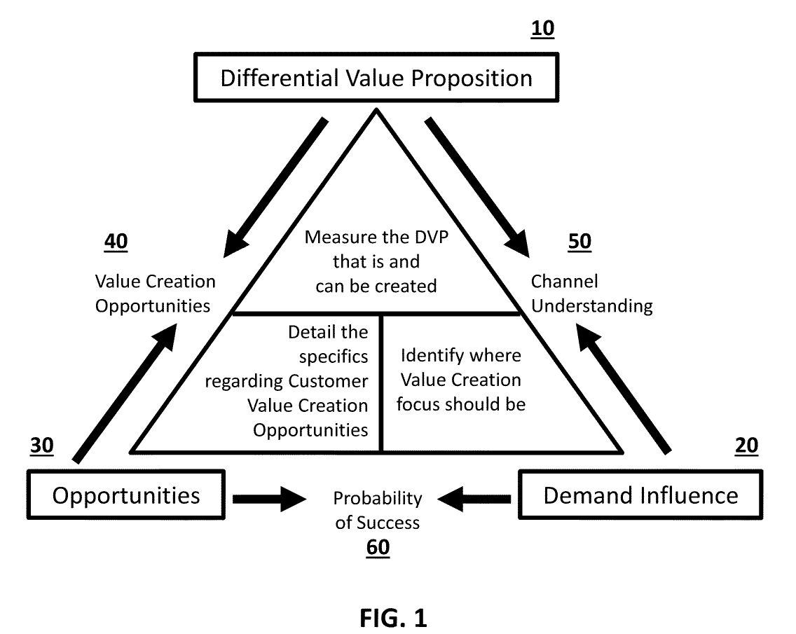

In one embodiment, the system comprises a CVC Dataset. As seen in FIG. 1, a CVC Dataset is an integrated schema of, at the highest level, three data types: Differential Value Proposition 10; Demand Influence 20; and Opportunities 30. At the highest level, the two key differentiators are the dataset and how the data integrates to form a system of understanding customer value creation. Each individual piece of the dataset is collected to better understand how organizations impact their customer's profitability so that these organizations better know where to invest to create a differential competitive advantage. The three pieces of the dataset are described in detail below.

Differential Value Proposition: This element (DVP) is the ability of the organization's products and services to positively impact their customer's bottom line relative to the organization's competitors. In sum, the ability of the organization's customers to make more money doing business with the organization than with its competitors. The ability to create a DVP can be correlated to the investments and strategies made by the organization on an ongoing basis. The connection between an organization's investments and strategies, and their customer's bottom line, comprises three parts: the investments and strategies that an organization makes (Value Attributes); the relative importance or impact each investment or strategy has on a customer's bottom line (Value Attribute Scores); and the combined, quantified economic or financial impact that all the Value Attributes have on a customer's bottom line or profitability (Differential Value Proposition Percentage, or “DVP %”).

In one embodiment, the Differential Value Proposition Percentage (DVP %) is calculated as the total economic impact, in operating margin dollars, an organization has on its customer's bottom line divided by the amount of money a customer spends with that organization to buy, use, or interact with its products or services. In other terms, DVP % equals the profit that the organization's DVP contributes, divided by the amount of products or services the customer buys or uses. For example, if the DVP is $40,000, and the total amount of money spent by the customer is $1,000,000, then the DVP % is 4%.

A DVP % scale may be used to indicate relative advantage. A DVP % of 0% means that the organization is equal to its competitors. A DVP % of less than 0% means that the competitor has the advantage. A DVP % of 2% indicates that the DVP is measurable, but thin, while a DVP % of 4% indicates a solid contribution to the client's bottom line, which higher percentages indicate relatively greater importance of the organization to the client.

The Differential Value Proposition may be measured in three stages: internally to create a baseline understanding; currently from the customer's perspective; and the customer's perspective on what the Differential Value Proposition can be.

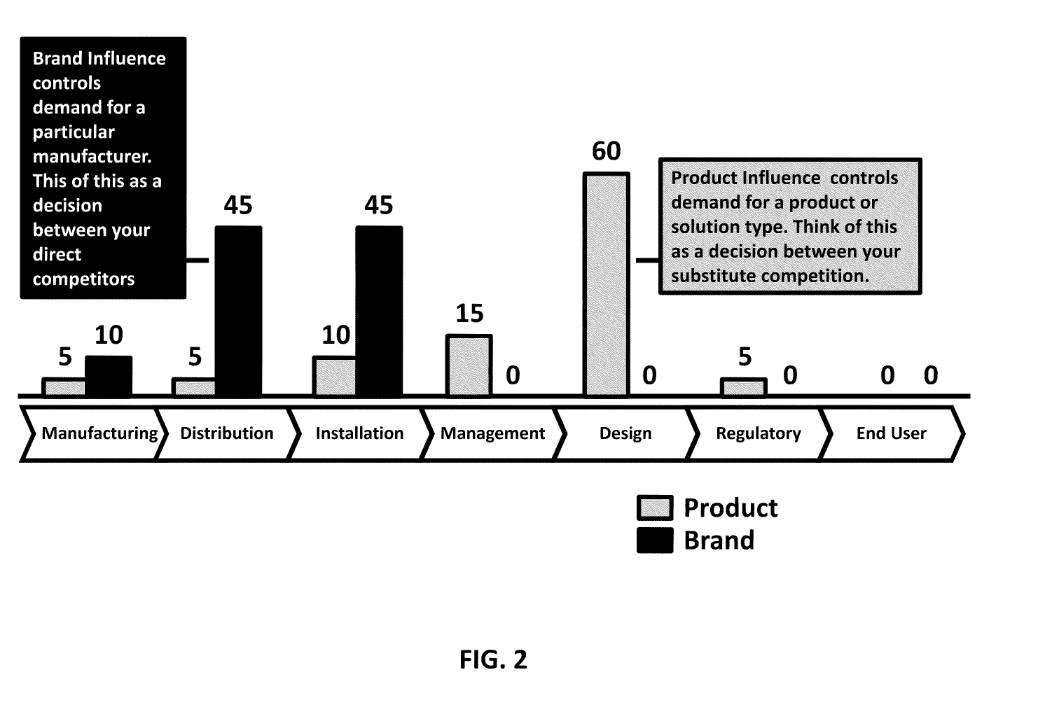

Demand Influence: The element comprises measuring market and channel influence to provide insight into where a Differential Value Proposition is critical (see FIG. 2). In one embodiment, it comprises a map of investment options within a given market, organization or channel that instructs an organization where a Differential Value Proposition % needs to be strong and where the investments to create a Differential Value Proposition should be focused.

Demand Influence Map may comprise three parts: which constituents in a given market, organization, or channel control demand for an organization's products or solutions currently; how the demand control will change in the future; and based on that information, where should the investment focus be placed.

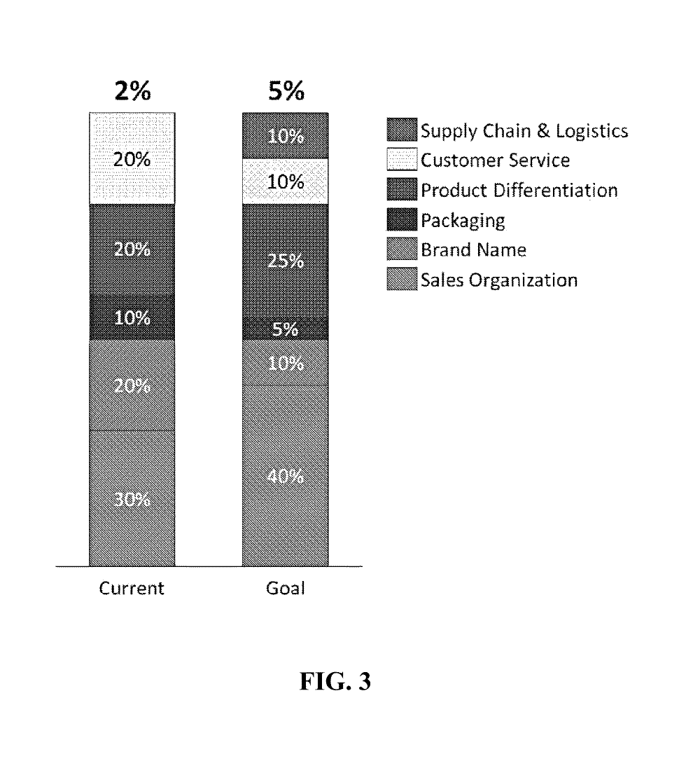

Opportunities: This element comprises the identification of opportunities to create incremental value for a customer. One approach comprises examining and explaining the difference between current DVPs and goal DVPs, as seen in FIG. 3. Examples of opportunities and their impacts include: (a) improving special order sales lead times, with the impact of freeing working capital and increasing the number of customers; (b) promoting use of recycled content for “green” products, with the impact of increasing the number of customers; and (c) and becoming more responsive to day-to-day needs, with the impact of reducing operating costs.

An investment detail may comprise two parts: specification of how an organization should invest to create differential value, and how that investment will impact a customer's profitability.

By combining individual pieces and Customer Value Creation data types, silos of information are turned into a system of knowledge. This system of knowledge provides the basis for managing the dataset above and beyond simplistic analysis. At the highest level, when two of the three data types are combined, a piece of the CVC data system is created. As shown in FIG. 1, these are Value Creation Opportunities 40, Channel Understanding 50, and Probability of Success 60.

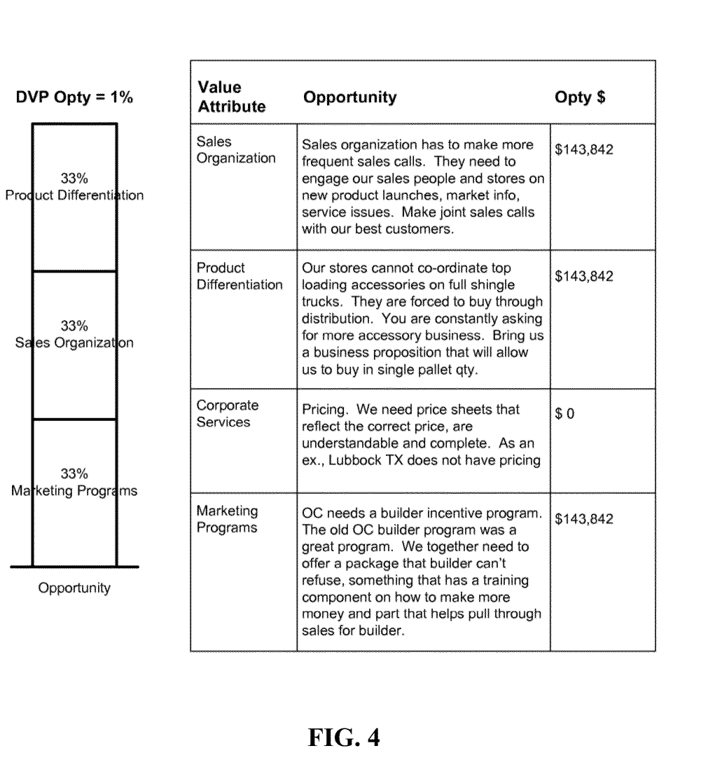

Value Creation Opportunity: As seen in FIG. 4, comparing the current DVP vs. goal DVP can lead to an understanding of how much value can be created; this data may be summarized as the Value Creation Opportunity. In one embodiment, this element comprises a quantified economic roadmap for an organization to create differential value for its customers. The investment details (i.e., Value Creation Opportunities) create incremental differential value for a customer with a relative impact within a portfolio of investments or strategies (i.e., Value Creation Opportunity Scores), and lead to the determination a quantified economic impact the portfolio of investments or strategies would have on a customer's bottom line (i.e., Differential Value Creation Opportunity Percentage). The Differential Value Creation Opportunity Percentage is calculated as the total economic impact, in operating margin dollars, an organization could have on its customer's bottom line in the event the investments and strategies specified were made, divided by the amount of money a customer spends with that organization to buy, use or interact with its products or services. In the example shown in FIG. 4, the DVP opportunity is 1% of incremental value that can be created. If the customer purchased $1 million in goods or services, then the Value Creation Opportunity is $1 million multiplied by 1%, or approximately $10,000. This calculation assists in prioritizing potential investments.

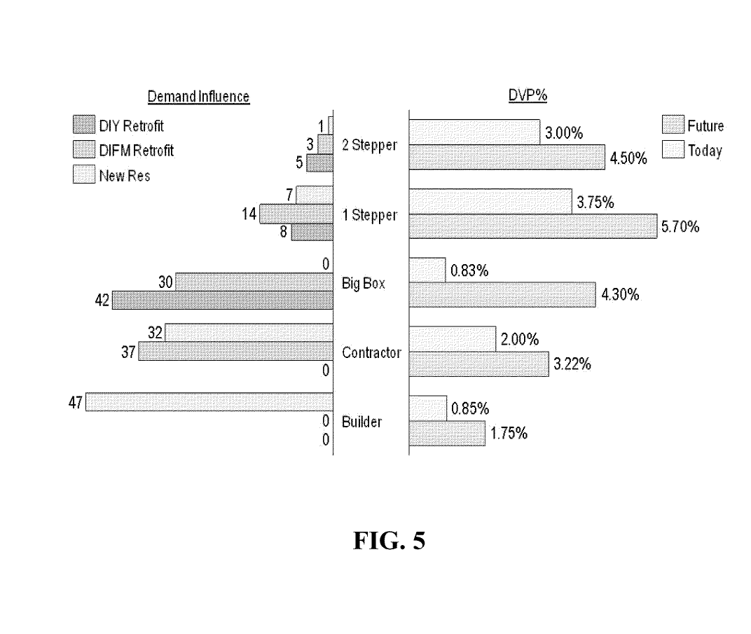

Channel Understanding: This element is the correlation between where differential value is being created today, where it can be created in a given market, organization, or channel, and where differential value needs to be created in order for competitive advantage to drive profitable growth. This understanding allows organizations to prioritize and align their potential investment portfolio with constituencies that offer the largest profit improvement opportunity for an organization. FIG. 5 shows an example of a comparison of Demand Influence and current DVP % to prioritize where to create value.

Probability of Success: The element comprises the link between creation of customer value and an organization's ability to capture their “fair share.” Combining Demand Influence and a value creation roadmap exposes whether the constituencies the organization plans on creating value for have the power to control demand in an organization's favor.

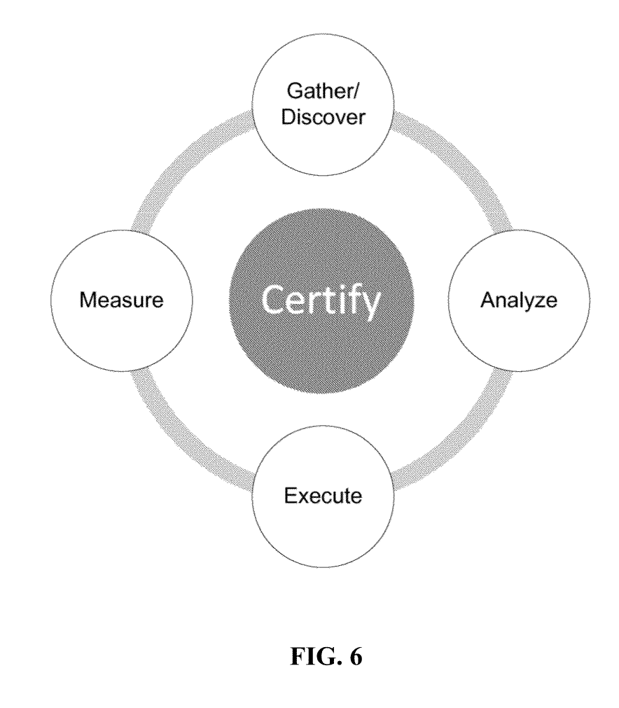

In another exemplary embodiment, the system comprises the CVC Approach, as seen in FIG. 6. The CVC Approach comprises the following modules or components: Gather/Discover 110, Analyze 120, Execute 130, Measure 140, and Certify 150. These modules, when combined, are the framework for managing customer value from an outside-in (i.e., customer-driven) perspective. By doing so, organizations create a competitive advantage by continuously optimizing return on investments made and eliminating the investments that are bound to fail. In the description of the CVC approach that follows, the CVC solution focuses on transforming the way client organizations create, deliver, and measure customer value, using a rigorous, quantitative approach.

In one embodiment, the CVC Approach comprises a computer program that implements the above modules in the appropriate order, collects and stores relevant data, and perform necessary calculations. The program may be run through an Internet web browser.

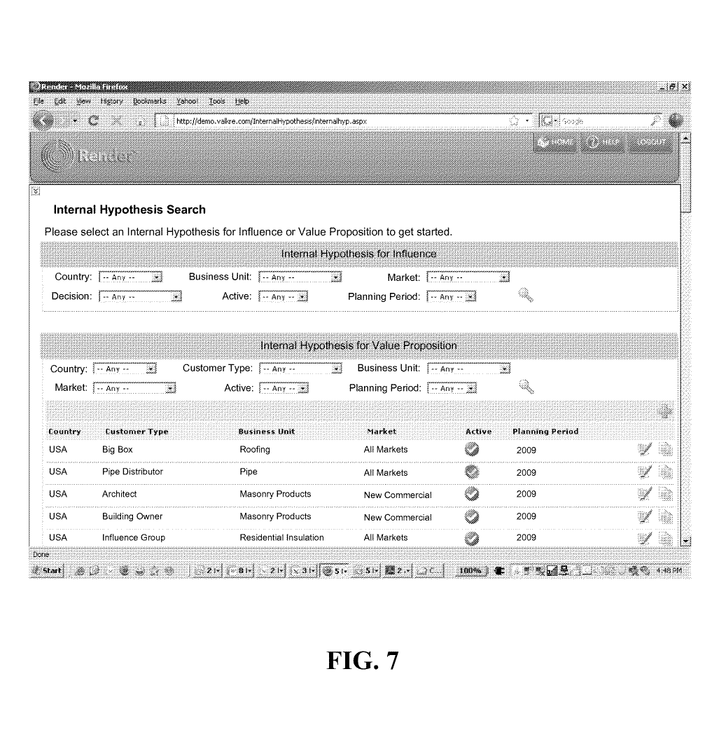

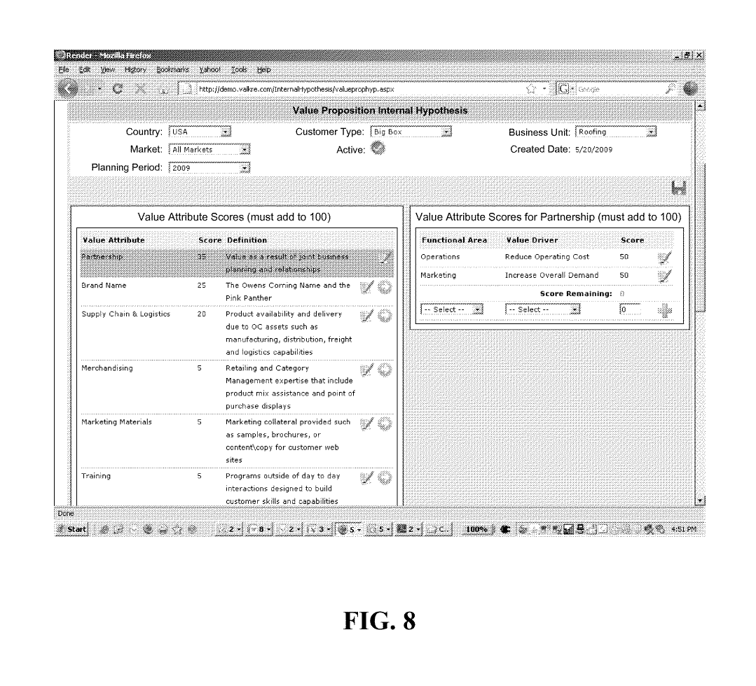

Gather/Discover: The Gather module collections and stores CVC Data. In one exemplary embodiment, as seen in FIGS. 7 and 8, the Gather module comprises an initial “Internal Hypothesis” step. This is the development of a quantified internal hypothesis for the Demand Influence and Differential Value Proposition data types to create a baseline internal understanding of customer value creation, and to generate the materials necessary to gain the customer's perspective. Internal Hypothesis data are stored in a database for both Channel Influence and the Differential Value Proposition.

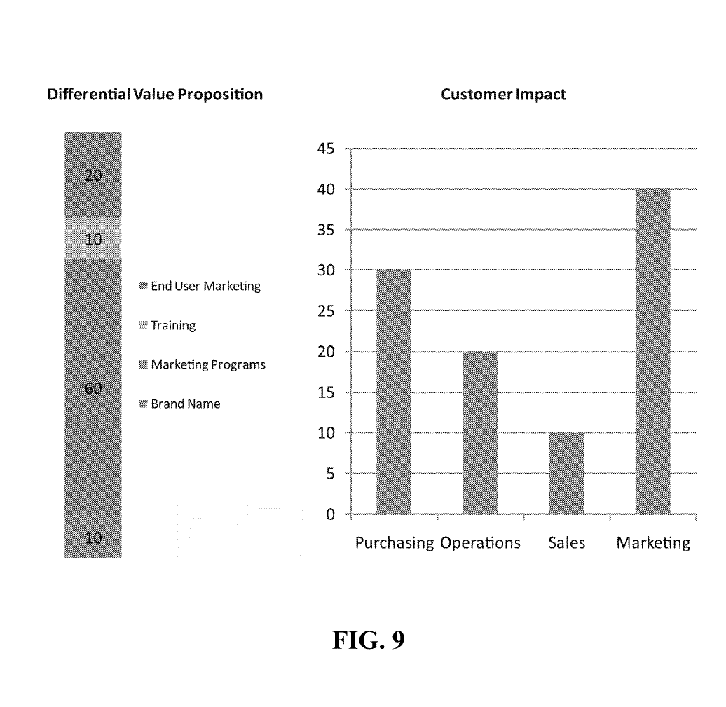

In one embodiment, an Internal Hypothesis is created in a minimum of three steps: (1) creating a Demand Influence Hypothesis; (2) creating a qualitative Differential Value Proposition model; and (3) quantifying a Differential Value Proportion Model. As seen in FIG. 8, the DVP Internal Hypothesis comprises value attributes, relative scores (which must add to 100), definitions, and value driver scores. For a particular value attribute, value drivers in particular functional areas are assigned scores, which must add to 100. The module assists the user in assigning appropriate scores to the value attributes and value drivers. These scores may be presented graphically to the user to help visualization, as seen in FIG. 9.

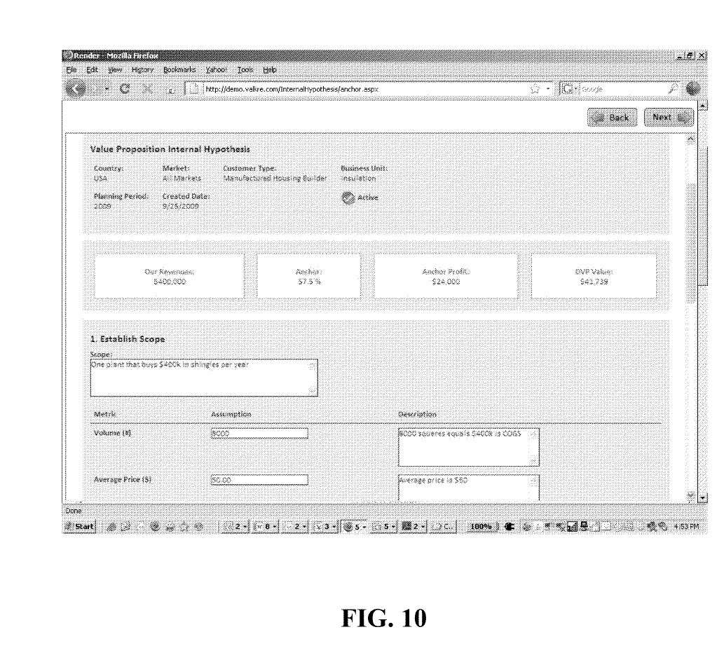

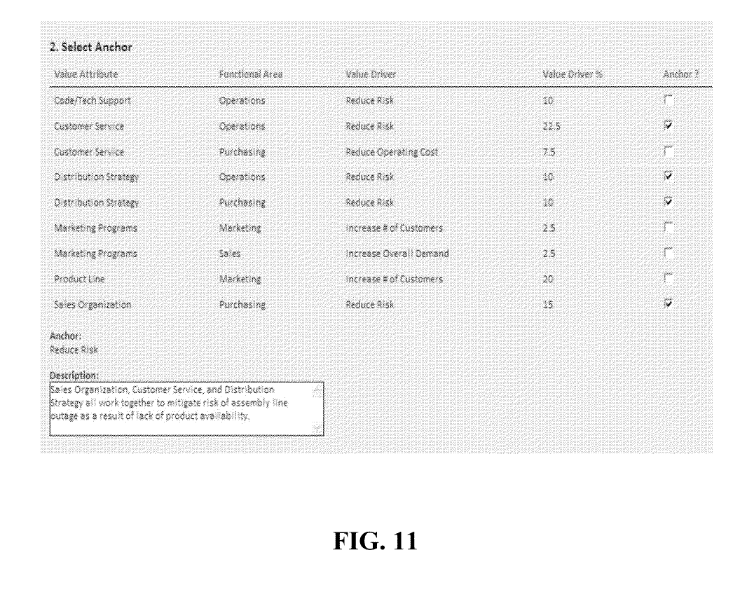

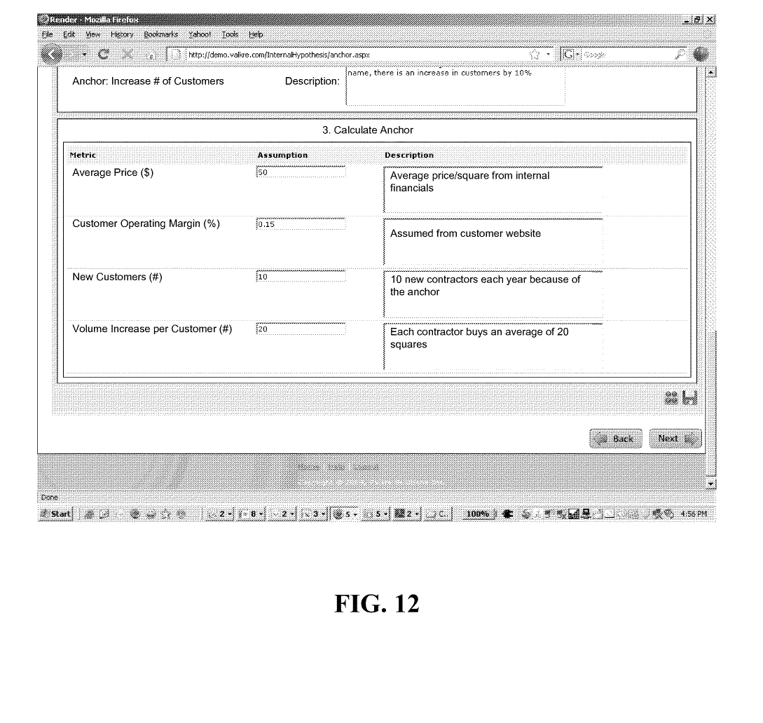

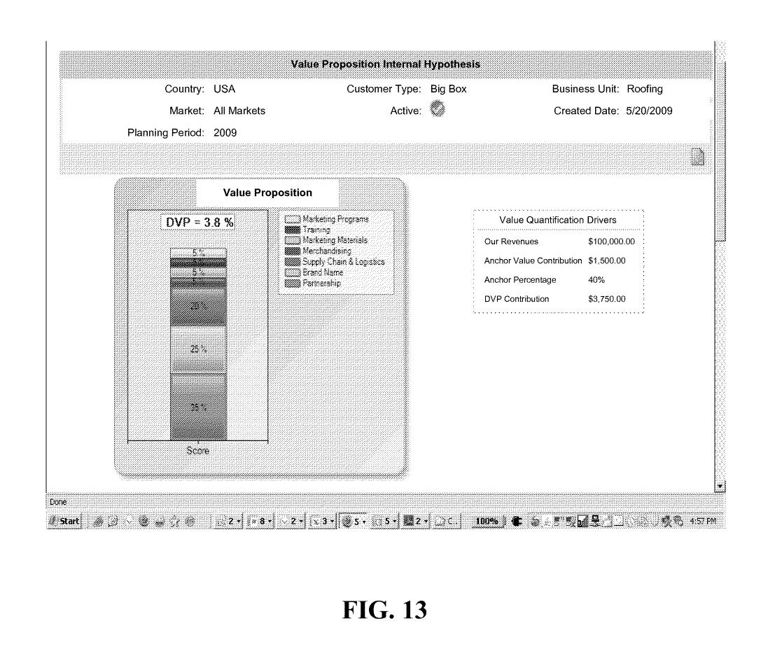

The Internal Hypothesis may be quantified using “anchoring” methodology, as shown in FIG. 10. The first step of this methodology is establishing the scope by determining the size of the customer. The second step is selecting the “anchor”; i.e., the part of the DVP that will be quantified, as seen in FIG. 11. The third step is quantifying the value that the anchor has on the customer's bottom line, as seen in FIG. 12. This calculation may be based on several metric, which may be assumed. Once anchoring is complete, the DVP may be quantified and depicted visually as shown in FIG. 13.

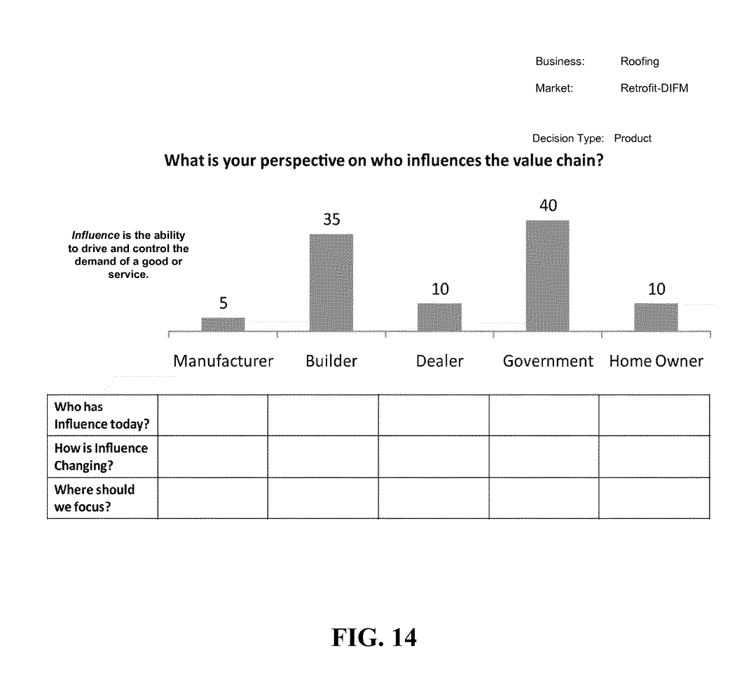

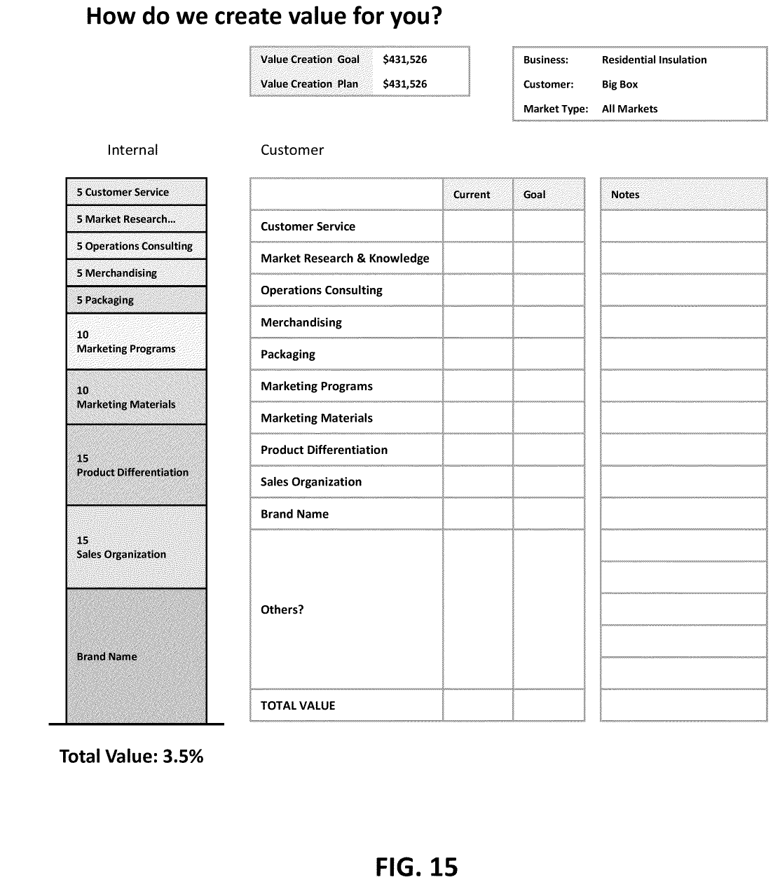

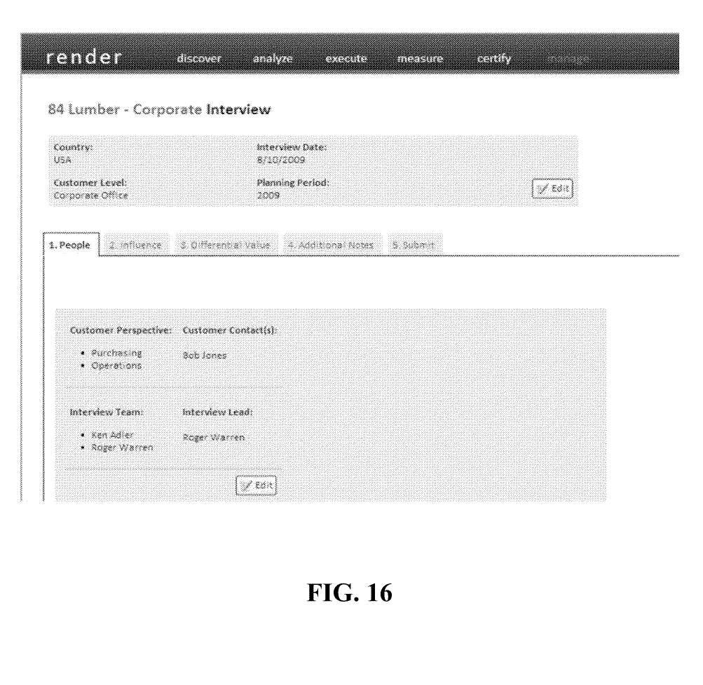

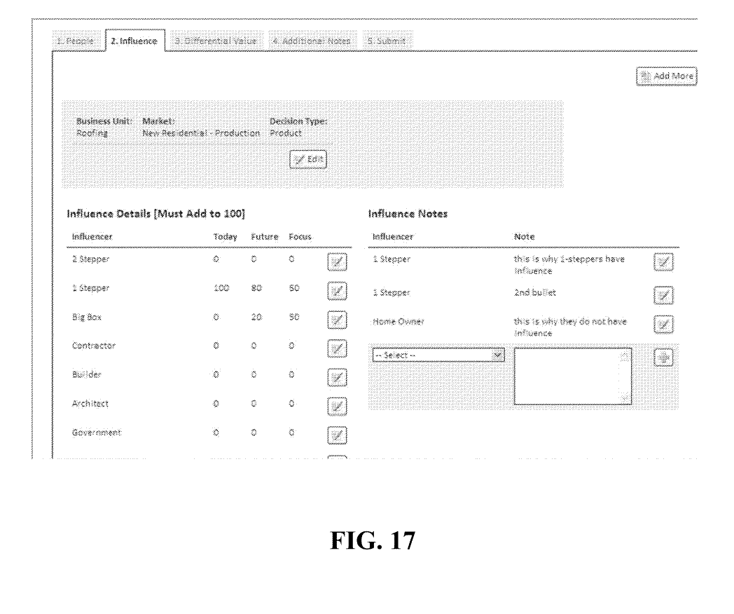

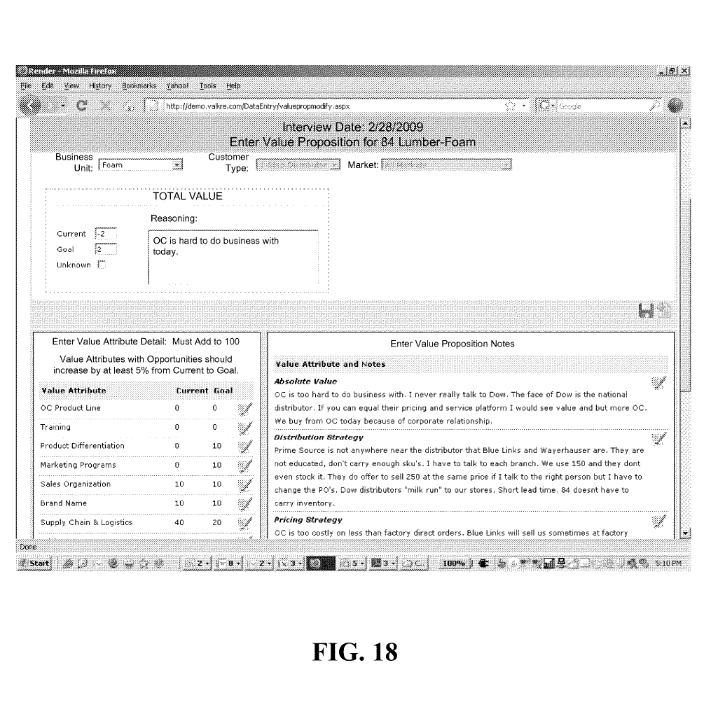

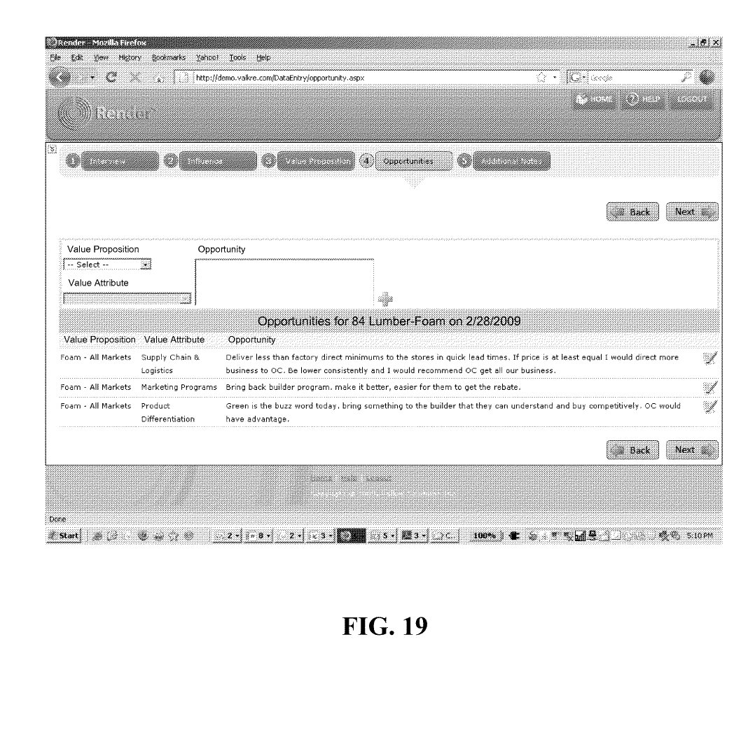

Once the Internal Hypothesis has been created, the system automatically creates a Discover Interview Guide to assist the user in collecting data from a customer. FIG. 14 shows the Channel Influence data collection template from the Interview Guide, while FIG. 15 shows the DVP data collection template. These can be completed by the user offline or online, through direct interaction with the customer. The system also may create a Discover Quick Reference Guide for use as a reference guide while gathering the customer's perspective and data. Once the customer interview is complete and data is collected, it may be entered into and stored in a system database. Entry may be accomplished by means of the Interview Capture Screen shown in FIG. 16, the Influence Capture Screen shown in FIG. 17, the DVP Capture Screen shown in FIG. 18, and the Opportunity Capture Screen shown in FIG. 19. The information may be stored in a standardized format such that it can be compiled and combined with other customer perspectives.

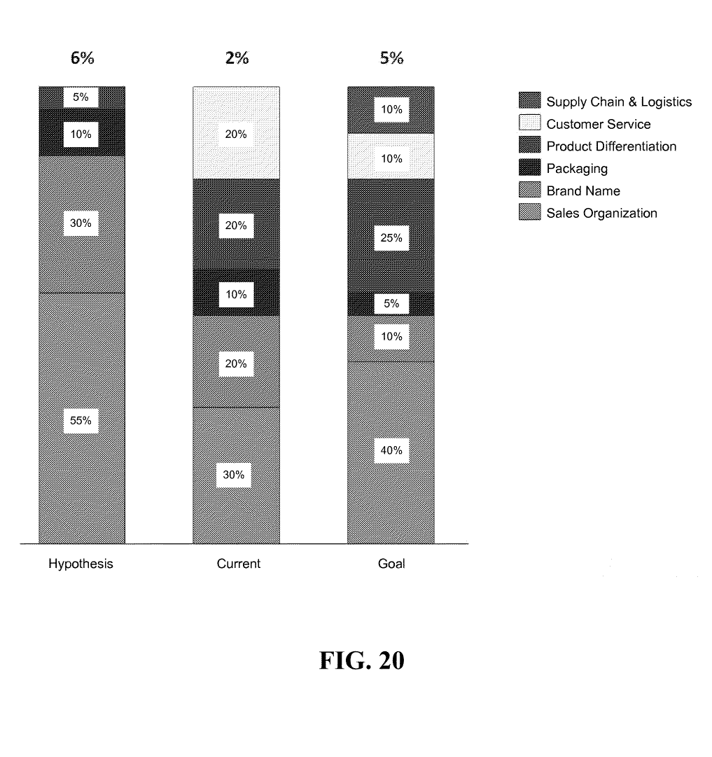

Analyze: The Analysis module processes the CVC data, and analyzes the Differential Value dataset across several components, including, but not limited to, customers, customer types, geographies, and businesses. As seen in FIG. 20, this may involve the comparison of the Internal Hypothesis (i.e., the organization's internal perspective) with the current perspective based on the customer's analyzable data set and the future perspective (or goal) based on the customer's analyzable data set. In one embodiment, the module comprises four components.

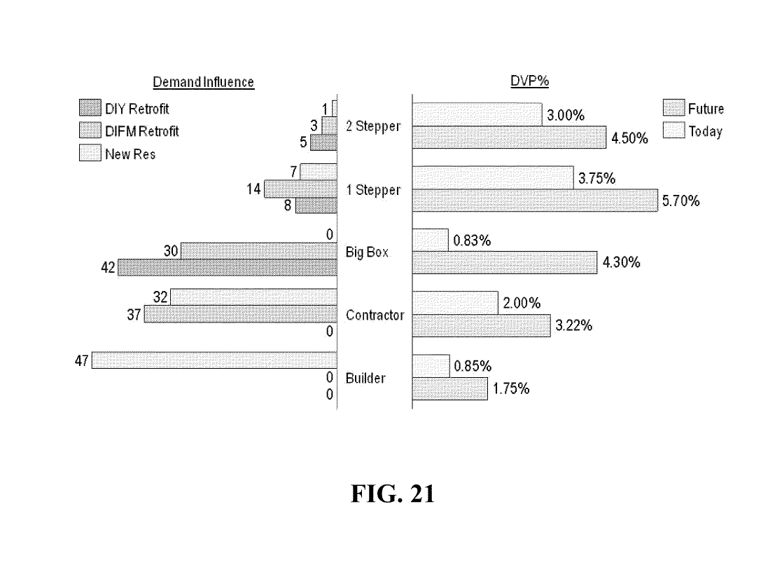

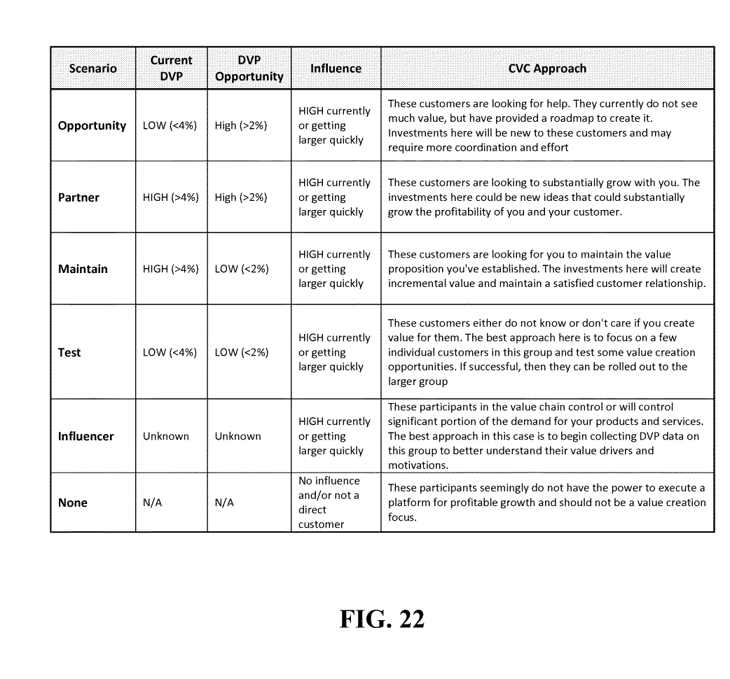

First, Value Creation Analysis analyzes Current Differential Value Proposition Data and Demand Influence to understand how much value is being created for customers and which investments should be a priority to create differential value such that competitive advantage is advanced or maintained. A graphical example of this analysis is shown in FIG. 21. Based on the combination of DVP and Demand Influence, organizations can invest in different ways. A table showing various scenarios based on these combinations is shown in FIG. 22.

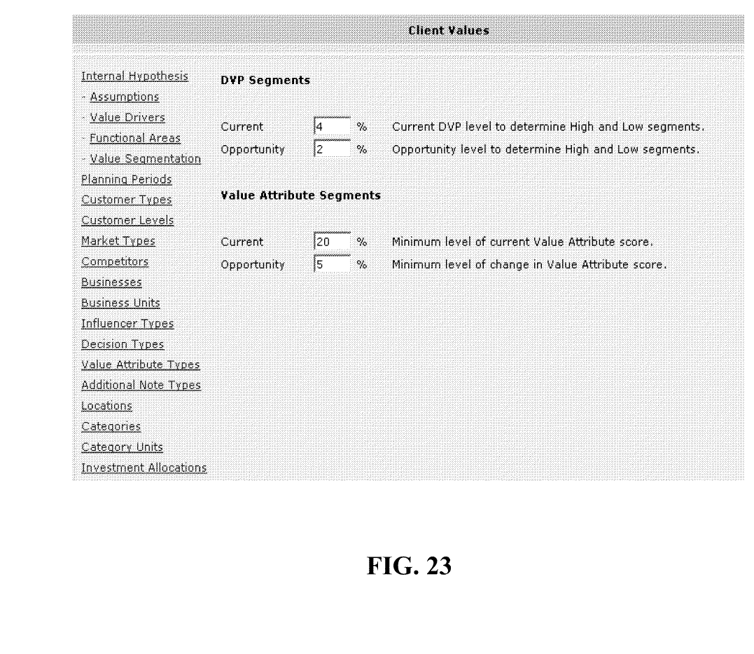

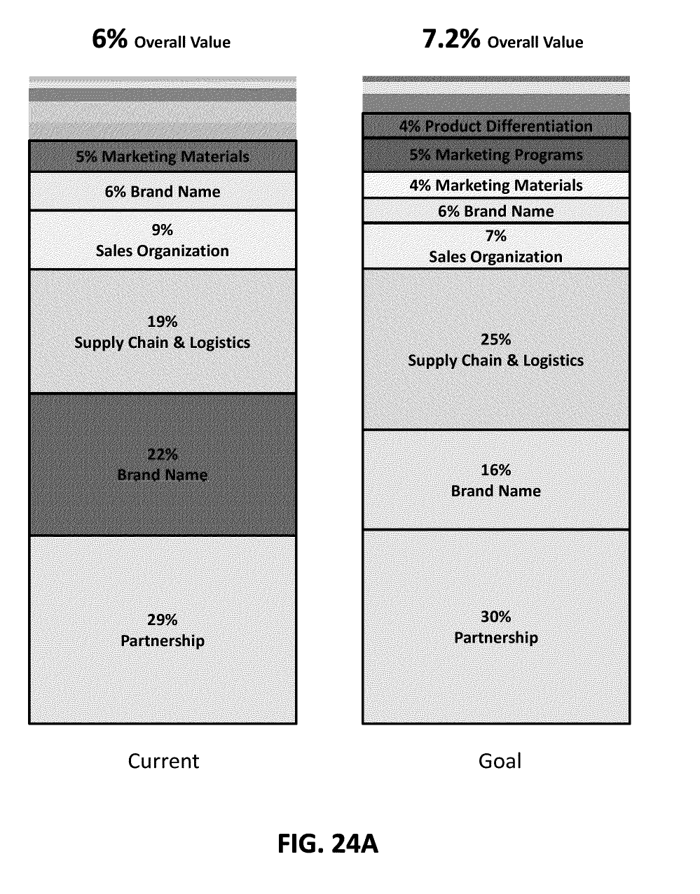

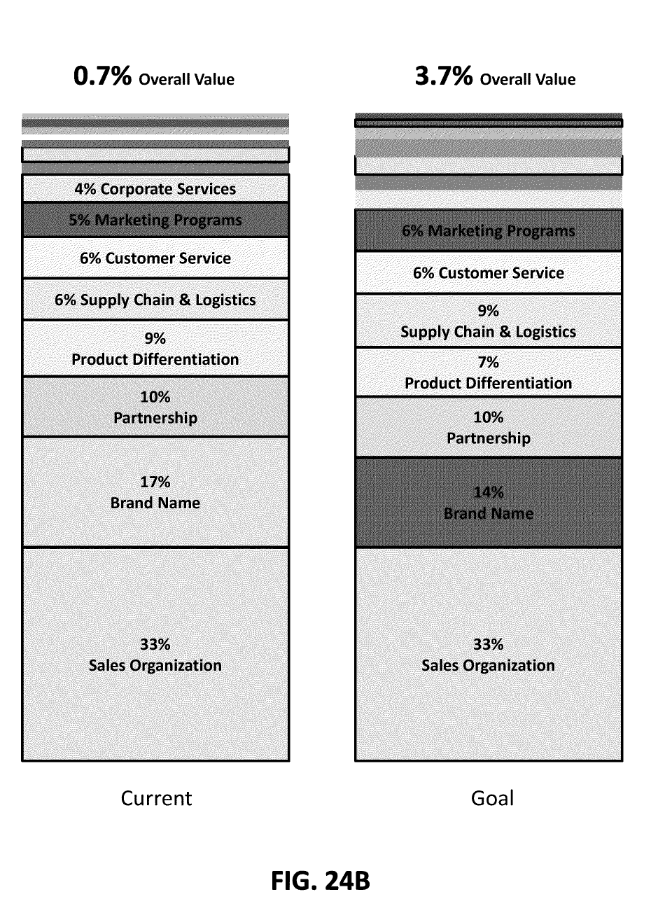

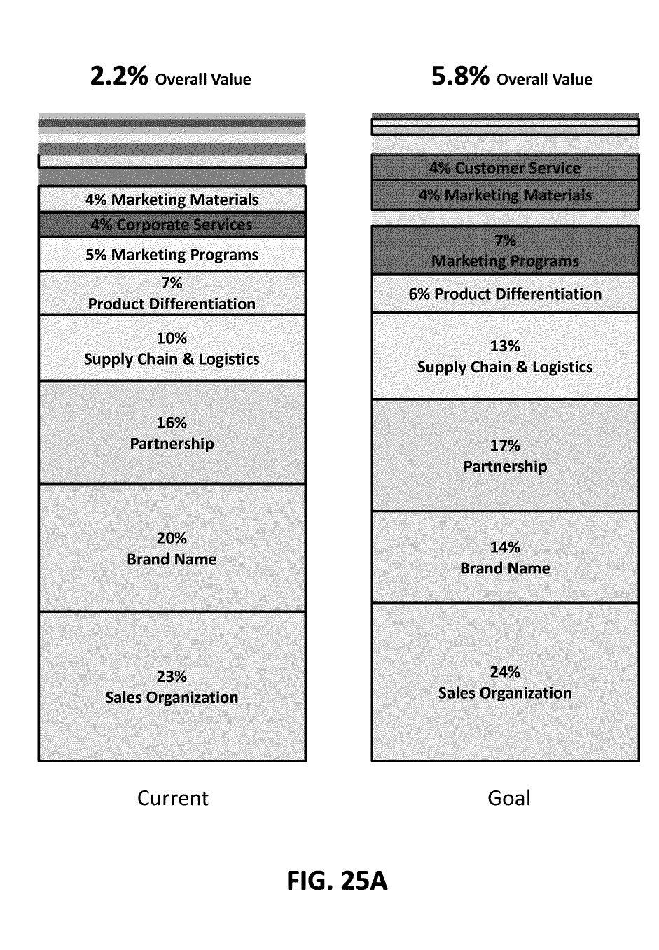

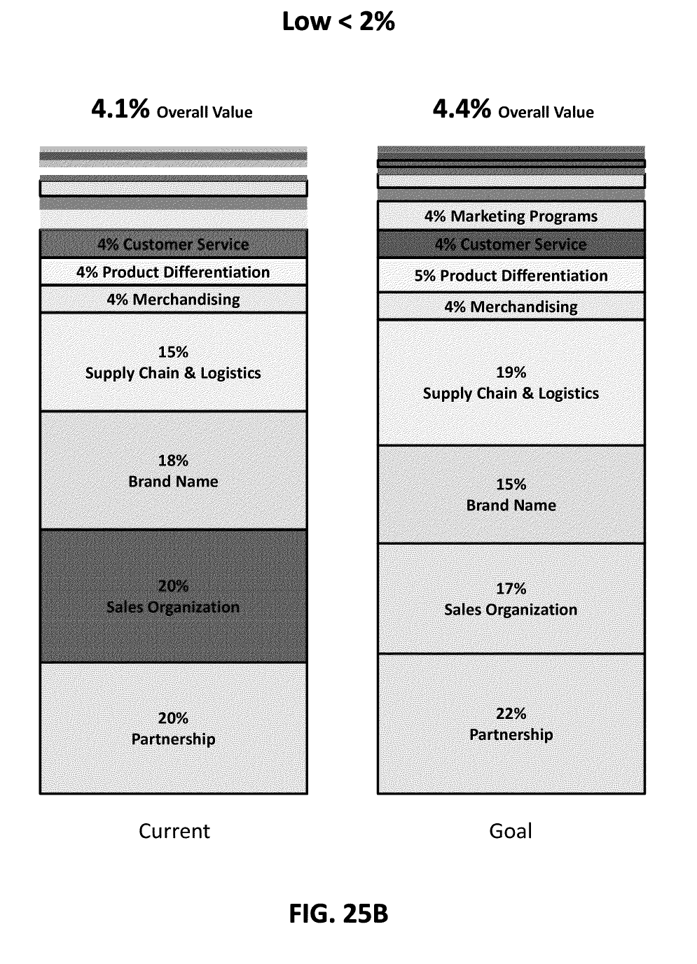

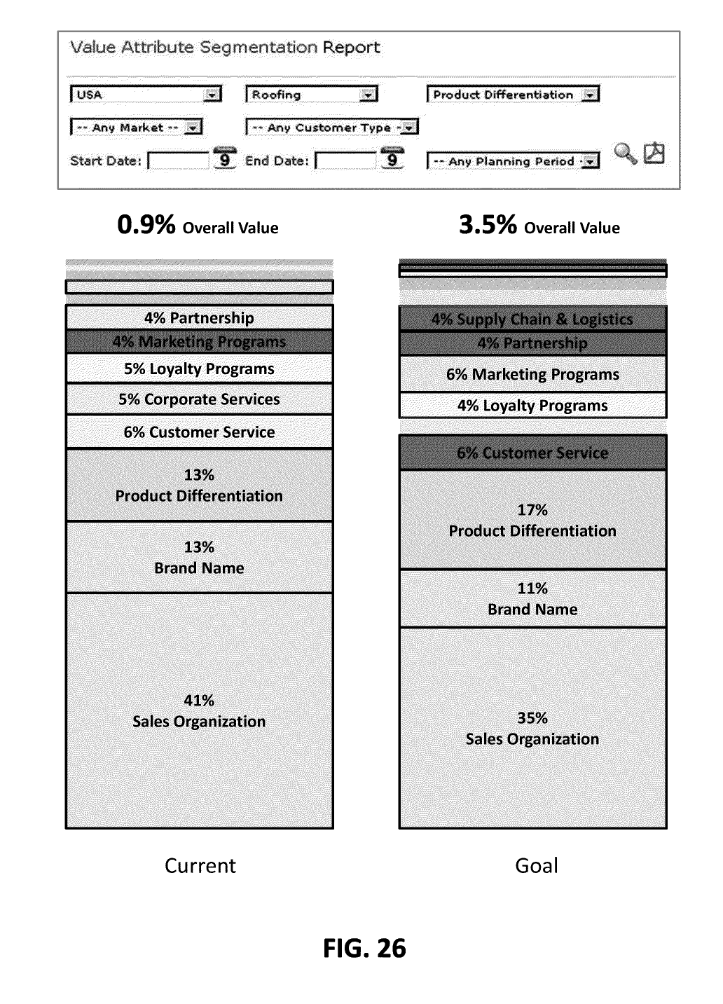

Second, Value Segmentation Analysis allows the segmentation, classification, and/or grouping of customers across businesses, markets, geographies, and the like, according to or based on their economic needs. Organizations can then invest in a selective and efficient fashion to maximize returns and eliminate waste. A setup screen for value segmentation criteria is shown in FIG. 23. The economic needs of customers can be shown graphically, as seen in FIGS. 24 and 25. FIG. 24 shows the exemplary needs of a customer with a strong DVP in comparison to a customer who does not see a strong DVP, while FIG. 25 shows the same for DVP growth opportunity. FIG. 26 show a value attribute segmentation report screen, showing an example of a customer who sees the same investments as an opportunity to create incremental differential value.

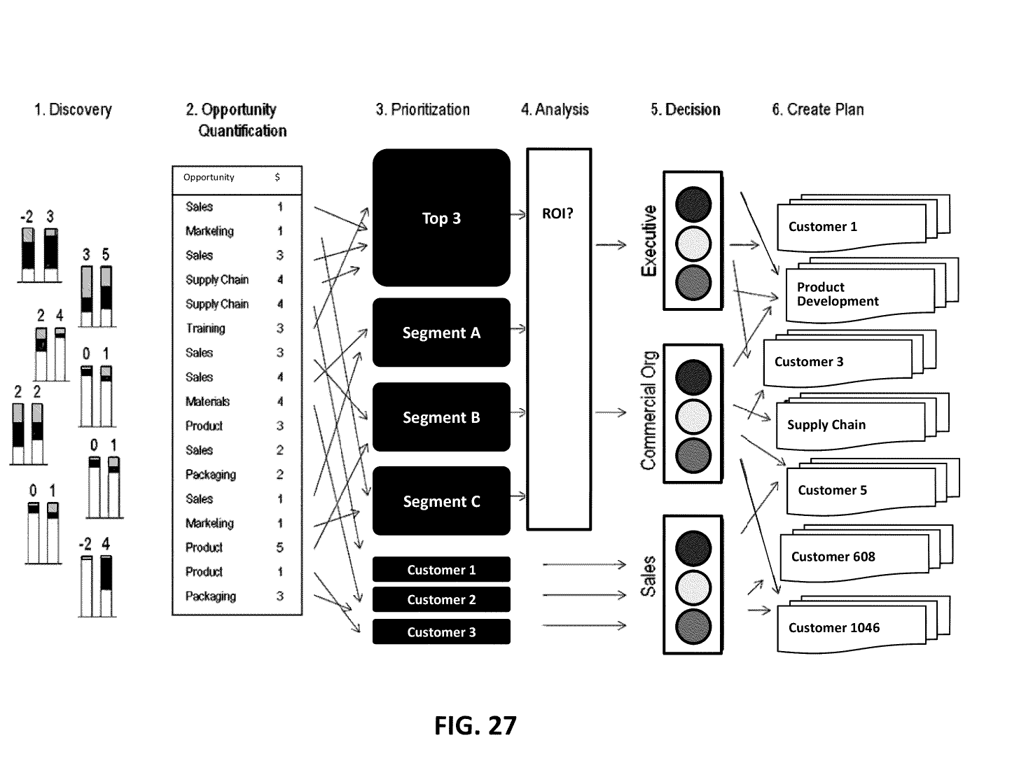

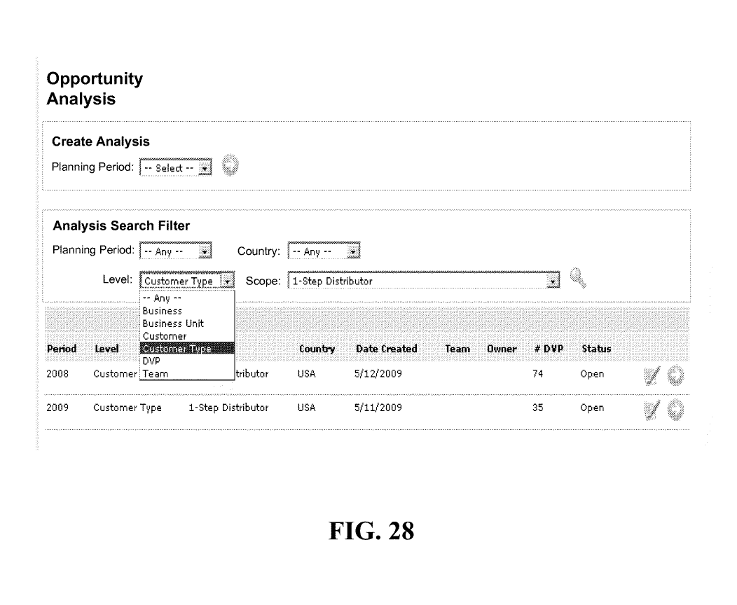

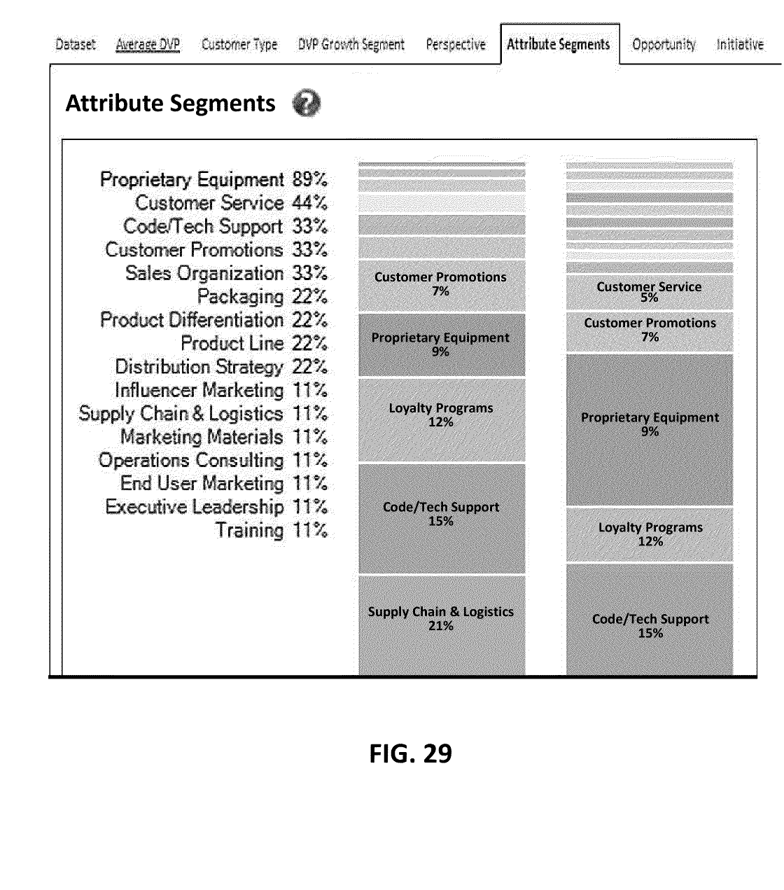

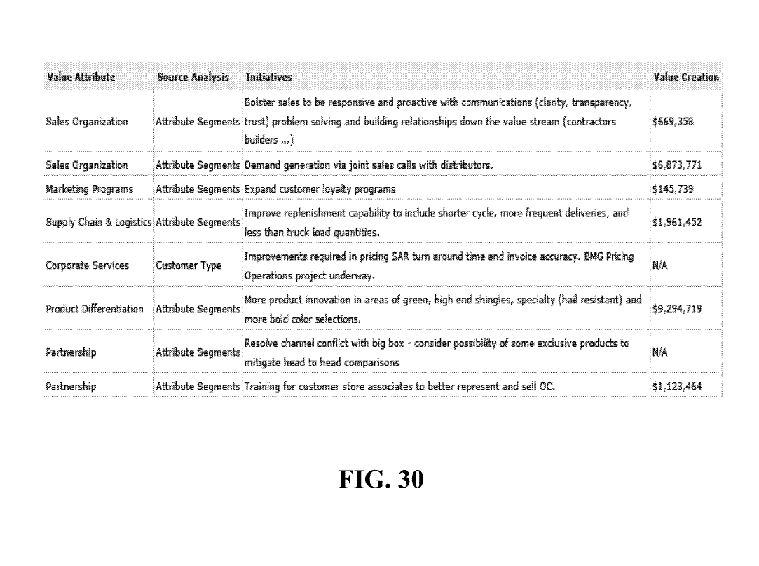

Third, Opportunity Analysis allows organizations to roll-up value creation opportunities across the entire analyzable data set, combine them, quantify them, build business cases, and make decisions (this process is shown graphically in FIG. 27). It allows the compilation of customer economic needs across businesses, business units, customer types, teams, DVPS, markets, geographies, and the like, and within large complex customer organizations, to identify and create a potential investment portfolio of value creation initiatives that is prioritized by the improvement opportunity to a customer's bottom line. FIG. 28 shows an opportunity analysis input screen with analysis search filters to identify an analysis dimension. Once an analysis dimension is identified, the opportunity dataset can be analyzed across many viewpoints, including segments, perspectives and levels with a customer organization, as shown in FIG. 29. The result of Opportunity Analysis is a quantified list of value creation initiatives, as seen in FIG. 30. This process takes hundreds of raw customer comments and data, and condenses them into initiatives that can be acted upon. Value creation quantification occurs by summing the value creation opportunity for each of the customers that informed the system of a given initiative.

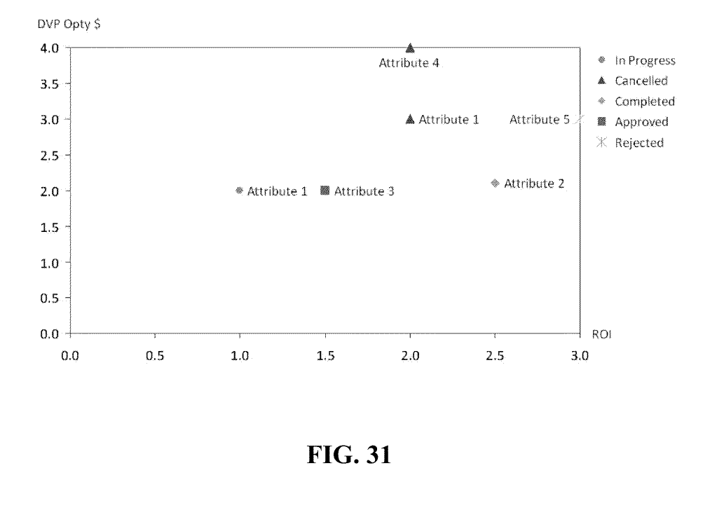

Third, Value Capture Analysis evaluates the potential investment portfolio, linking an organization's investment to its customer's profitability and, in turn, to the organization's own profitability, such that the evaluation of value creation and value capture can occur. In one embodiment, the analysis assembles each of the Value Creation Initiatives so business cases can be built to execute. At the core of each business case is the balance between Customer Value Creation (DVP Opportunity $) and the organization's return on investment (ROI). An example of a graphical depiction of this balance is shown in FIG. 31.

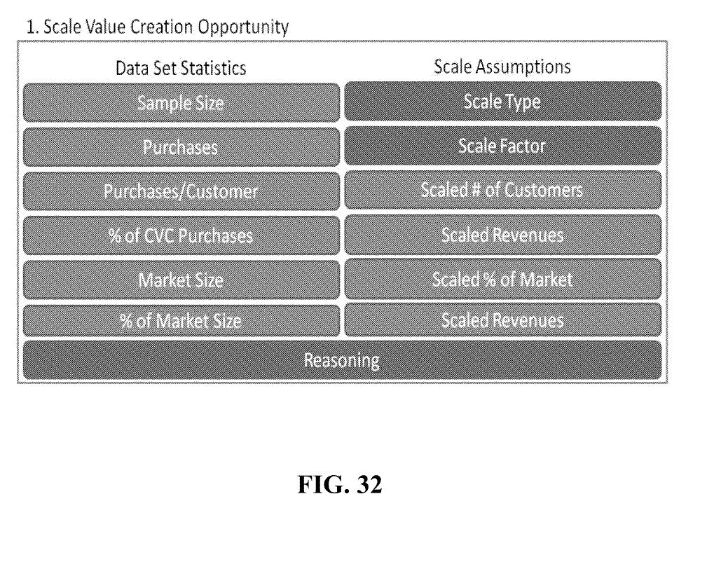

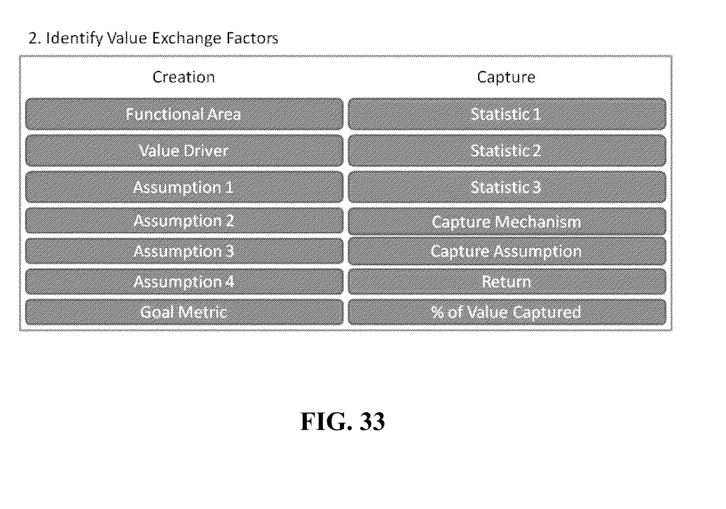

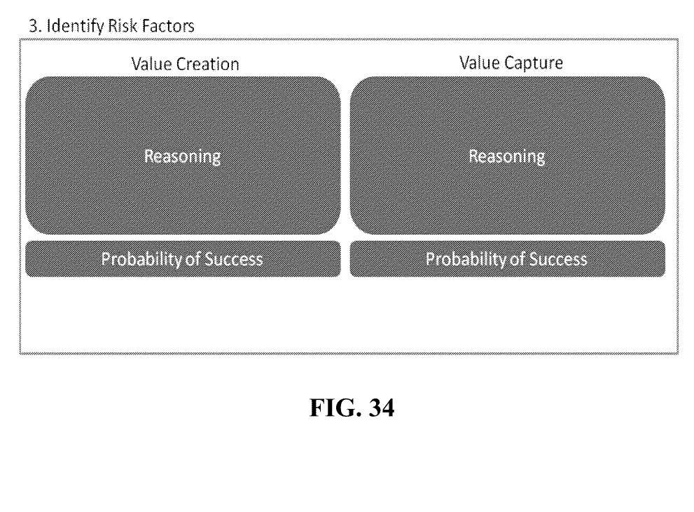

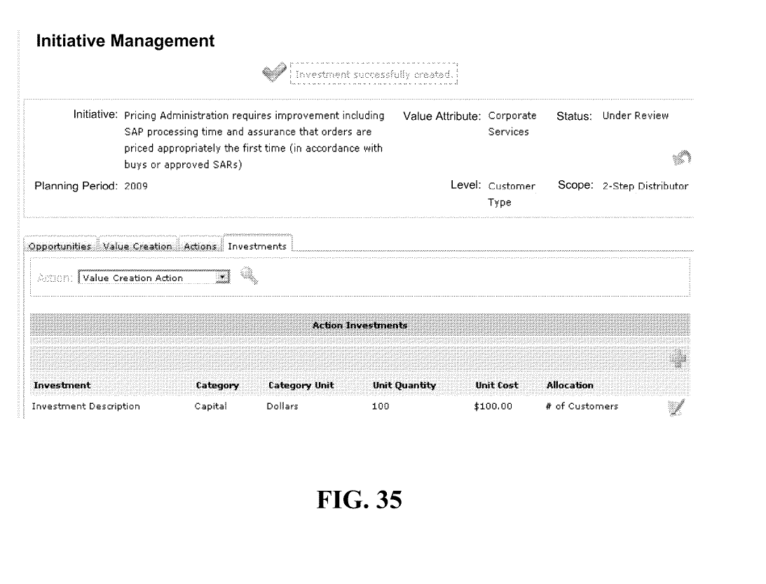

The first step of this analysis is to scale the value creation opportunity; i.e., create an accurate picture of the value creation opportunity by using sample size and market statistics (see FIG. 32). Next is identifying the value exchange factors (see FIG. 33). An understanding of how the initiative will impact the customer set's bottom line and the resulting mechanism for capturing value. Examples of these factors include, but are not limited to, share, price, volume, and cost reduction. Relevant statistics are provided depending on the Value Drivers that provide direction on which value capture mechanism is more probable. Once the identification is complete, the expected return is calculated. The next step in calculating the value creation and value capture portion of the business case is the identification of risk factors, and how those might affect the probability of success (see FIG. 34). The business case for creating value also includes the investment required to execute. An example of an investment selection screen is shown in FIG. 35. Once the value creation, value capture, and investments are modeled, a business case framed for a decision on execution (see FIG. 31).

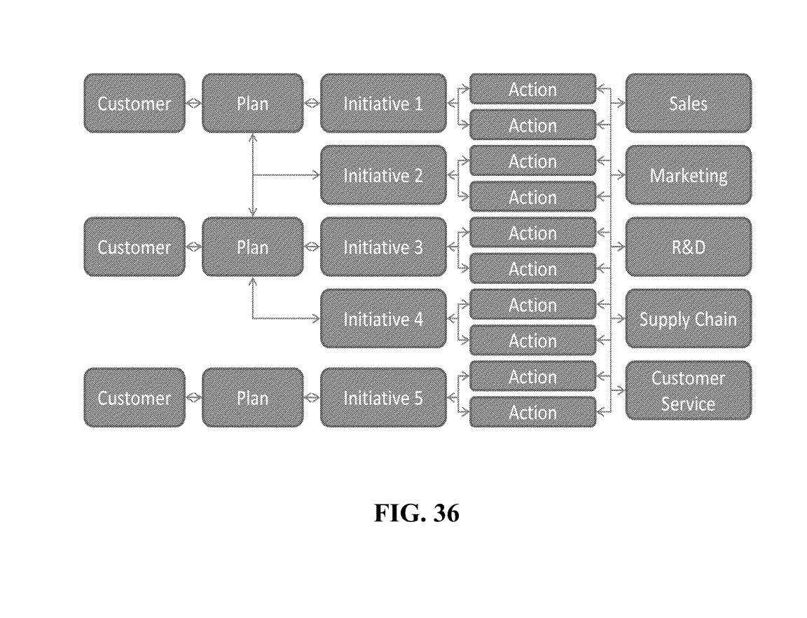

Execute: The Execute module takes the results of the Analyze module and delivers the CVC initiatives identified while capturing an organization's fair share. The module is based on an integrated data schema that connects customer value creation activity to all aspects of an organization and its customers (see FIG. 36). In one embodiment, this occurs through enterprise collaboration in four dimensions or components: customer value creation planning; value creation initiative management; value creation action execution; and integration of CVC with existing commercial and non-commercial functions in an organization.

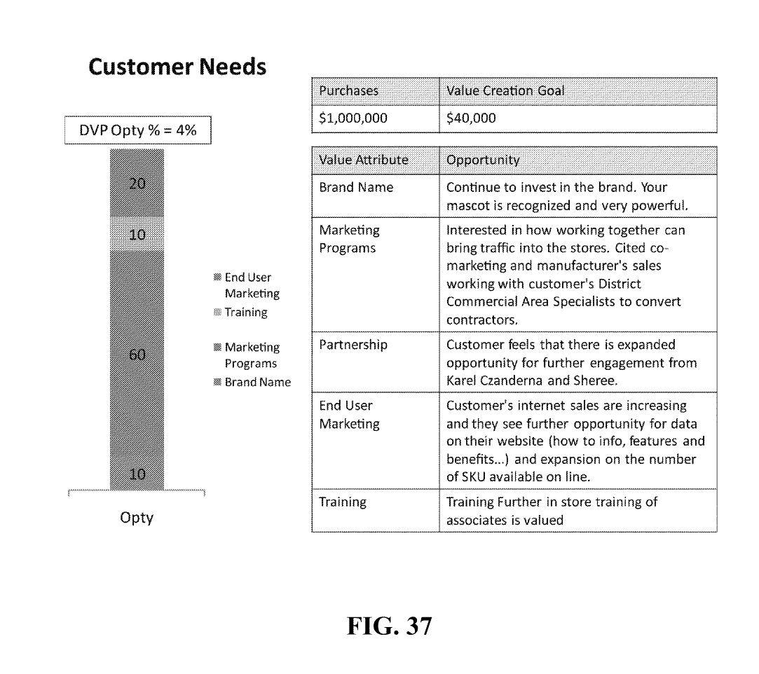

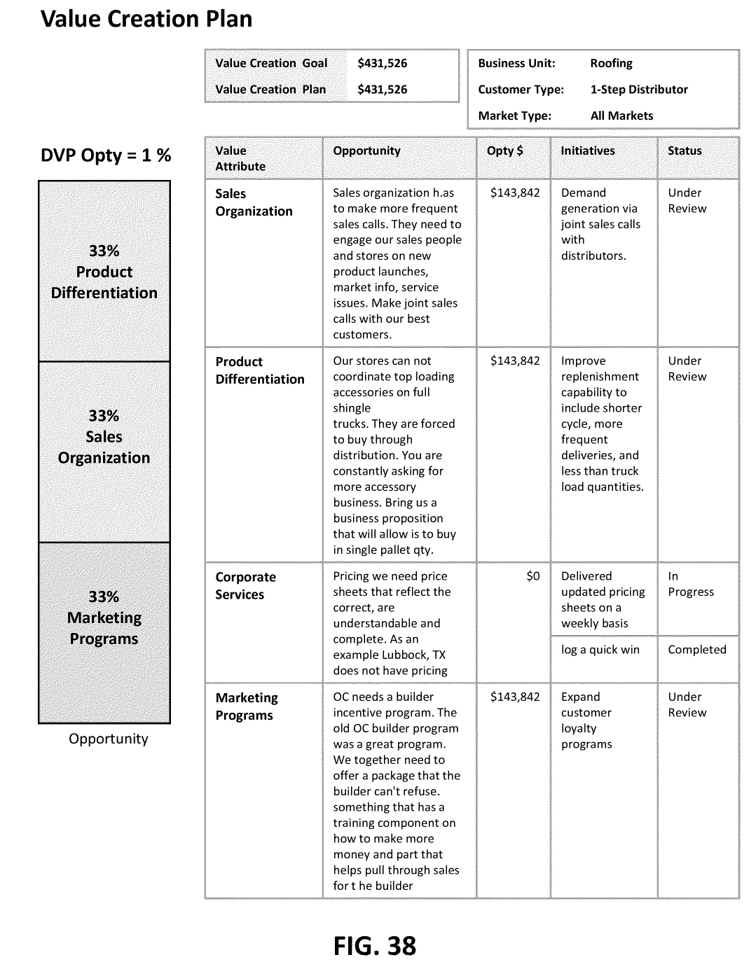

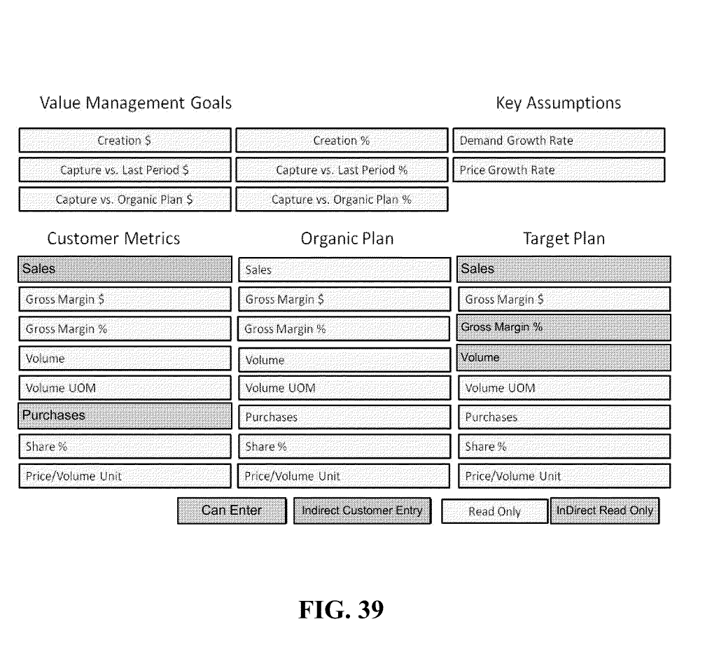

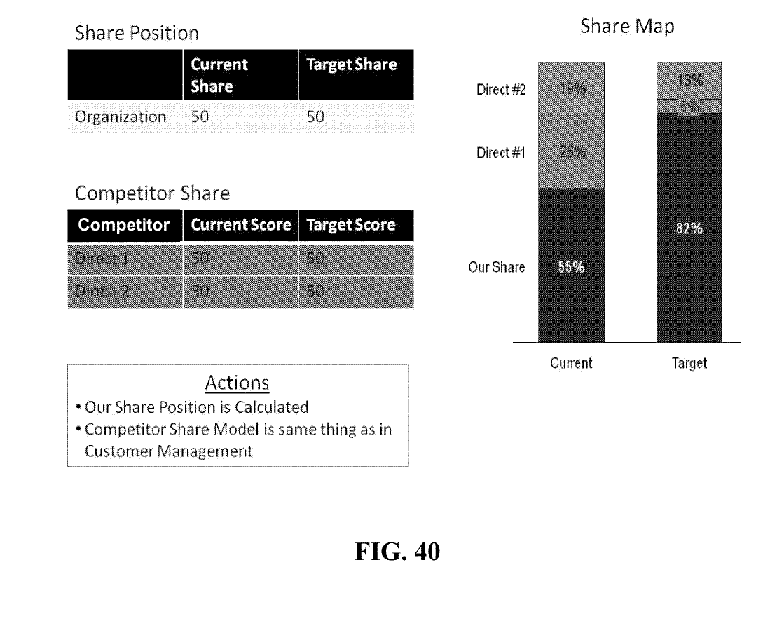

The Value Creation Planning component documents the value creation and value capture roadmap on an individual customer basis that can be communicated internally and externally. The Value Creation portion of the plan includes the direct response to the value creation opportunities identified during the Gather (or Discover) module. This response comes in the form of CVC initiatives and their current status. The customer's needs are quantified in terms of the customer's economics (see FIGS. 37-38), and includes Value Creation initiatives identified during Opportunity Analysis as well as initiatives that are specific to that given customer. The Value Capture portion of the plan includes the specific returns expected to the organization as a result of executing the value creation plan, and allows a user, such as a sales representative, to forecast incremental gross margin dollar gains as a result of creating customer value (see FIGS. 39-40).

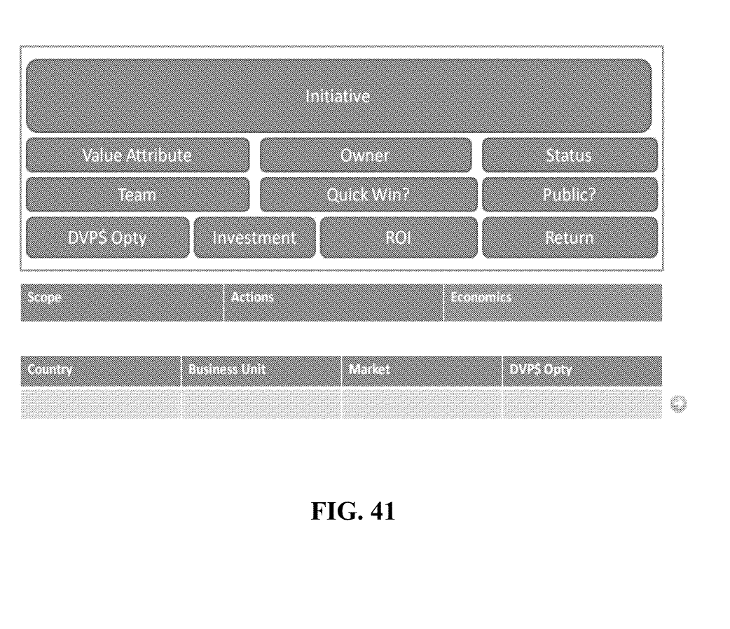

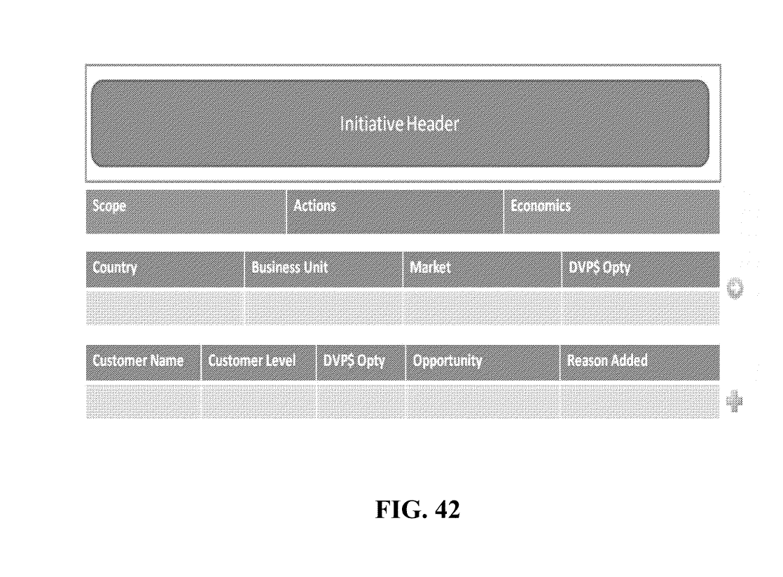

The Initiative Management component manages initiatives, the direct response to a given opportunity in a Value Creation Plan. An initiative is a cross-functional execution item that quantifies the value creation and value capture economics (see FIG. 41). Initiatives are owned by various functions in an organization, and thus serve these functions as a direct link to their customers. Each initiative being executed to create differential customer value is managed centrally by an initiative owner, but is still connected to all customers who informed the initiative during the Gather (or Discover) module. Each initiative has the capability to include multiple customers, and therefore, multiple plans (see FIG. 42). For example, if an initiative that was informed by 50 different customers is updated or completed, the communication to each of those 50 customers will be done automatically through the Value Creation Plan. Accordingly, organizations can be directly linked to CVC through the management of initiatives.

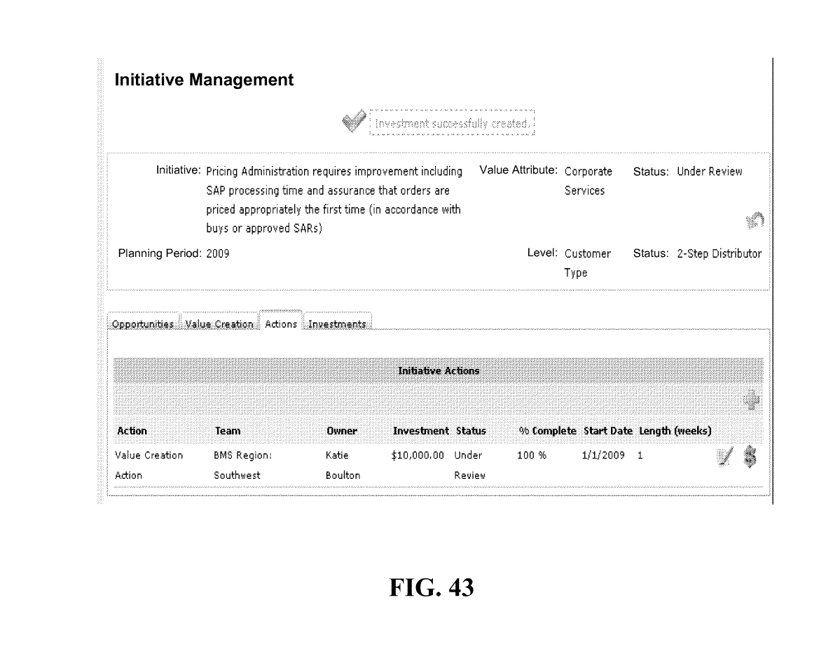

The Action Execution component details the action items (i.e., measurable execution items) that make up the execution roadmap for a given initiative. These are the things that, when executed, create value and provide organizations with the ability to capture value. This facilitates the execution of a cross-functional initiative that is centrally managed and communicated similar to value creation initiatives. Each action can be owned by a different team (see FIG. 43), thus creating the potential for a cross-function execution team for the organization.

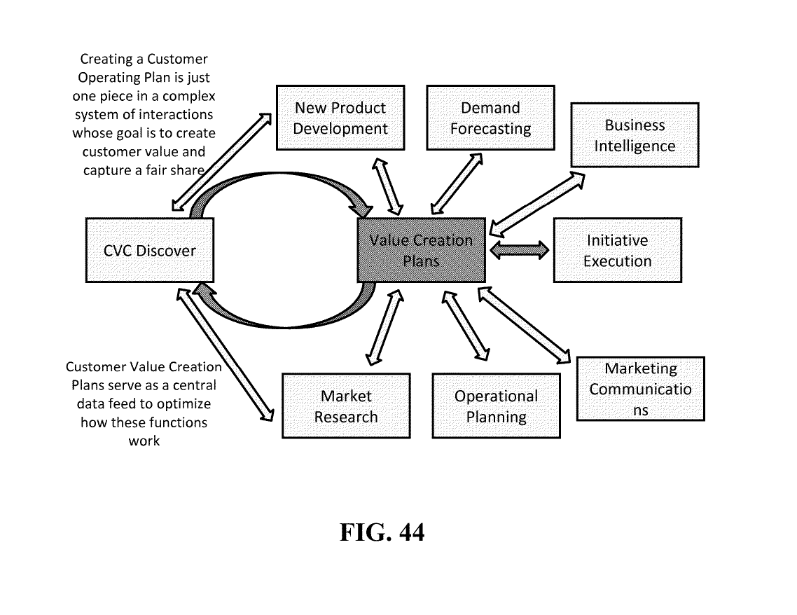

In the Process Integration component, value creation plans, initiatives, and actions are integrated into organizational processes to drive the execution of customer value creation. This can include assigning initiatives and actions to functions that typically are not connected to the customer, such as R&D, Customer Service, and Marketing Communications (see FIG. 44).

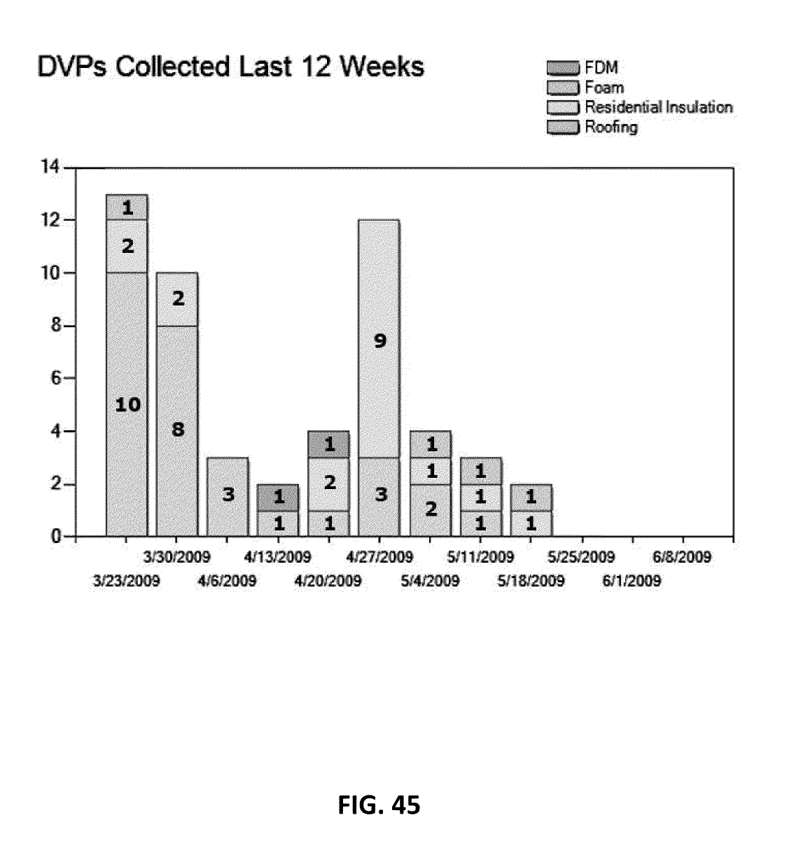

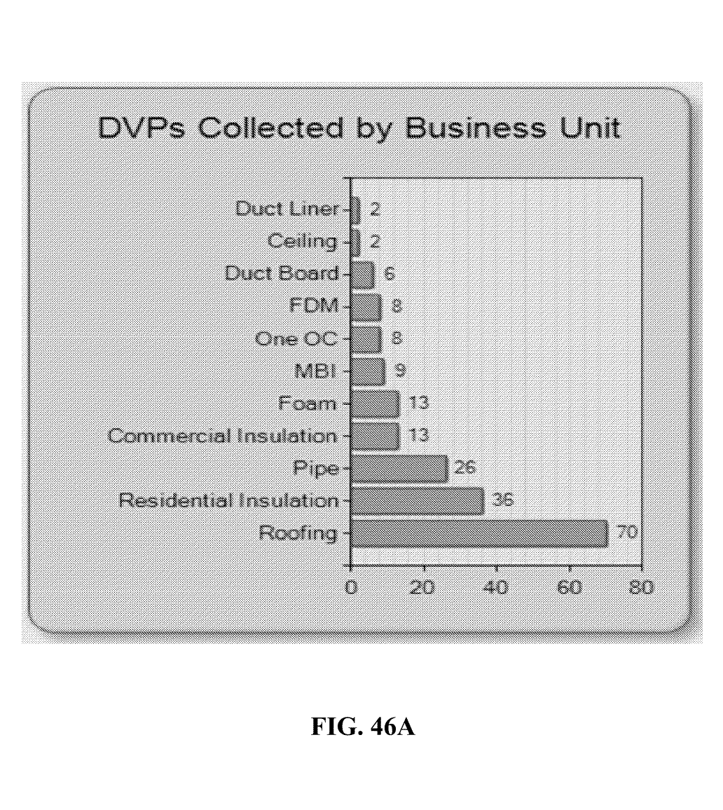

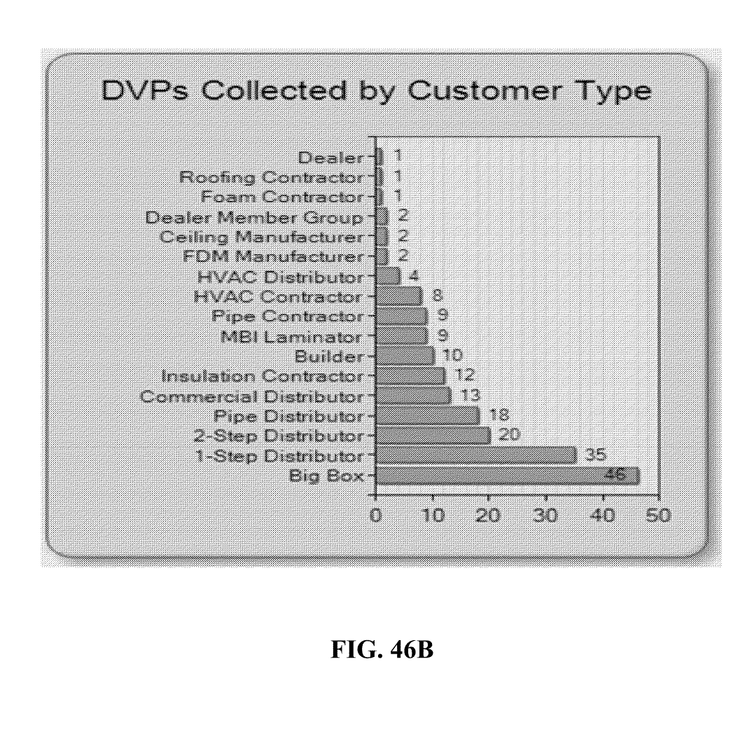

Measure: The Measure module drives an environment of learning and continuous improvement by measuring the activities of the Gather/Discover, Analyze, and Execute modules through a series of integrated data dashboards and additional data collection methods. In one embodiment, the Execution Dashboard measures the data collection effort on a periodic basis (e.g., daily, weekly, monthly) to evaluate the CVC dataset and ensure it is complete and balanced to reduce the potential of biased results. Historical collection measurements can be viewed, as shown in FIG. 45. Data collection can be measured across various dimensions, such as (but not limited to) Sales Rep, Sales Team, Region, Perspective, Customer Type, Country, and Business Units, among others (see FIG. 46).

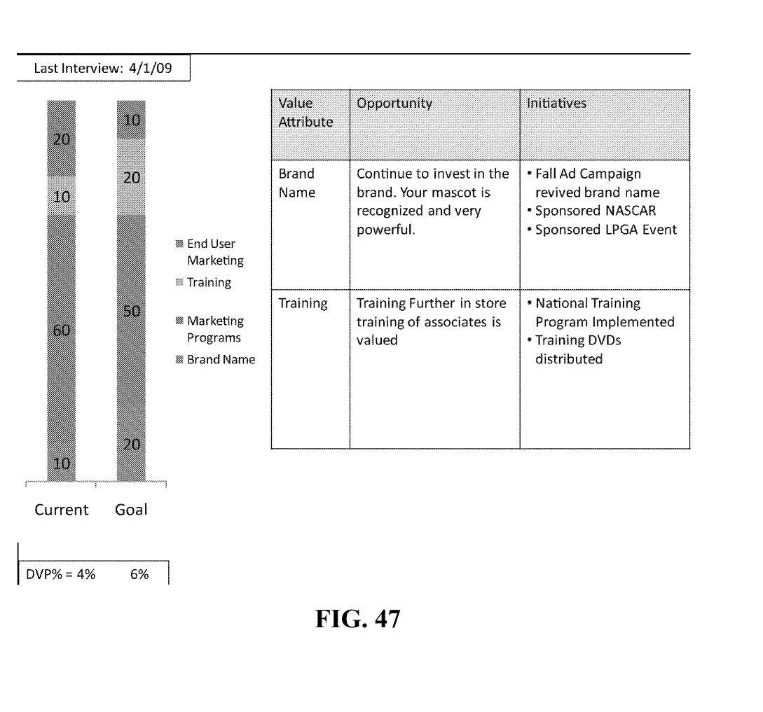

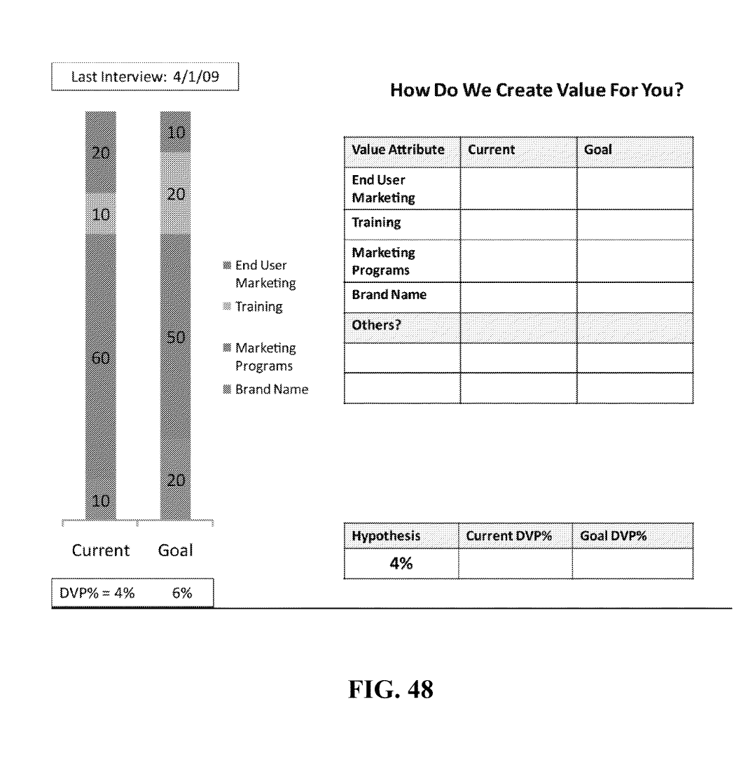

The Discover Value Creation Progress dashboard or process, similar to the data collection portion of the Gather/Discover Module, collects the customer's perspective on progress being made on a Value Creation Plan. Measuring Value Creation progress involves the customer, and reviews what was accomplished since the last data collection effort, as well as seeking customer input (see FIGS. 47-48).

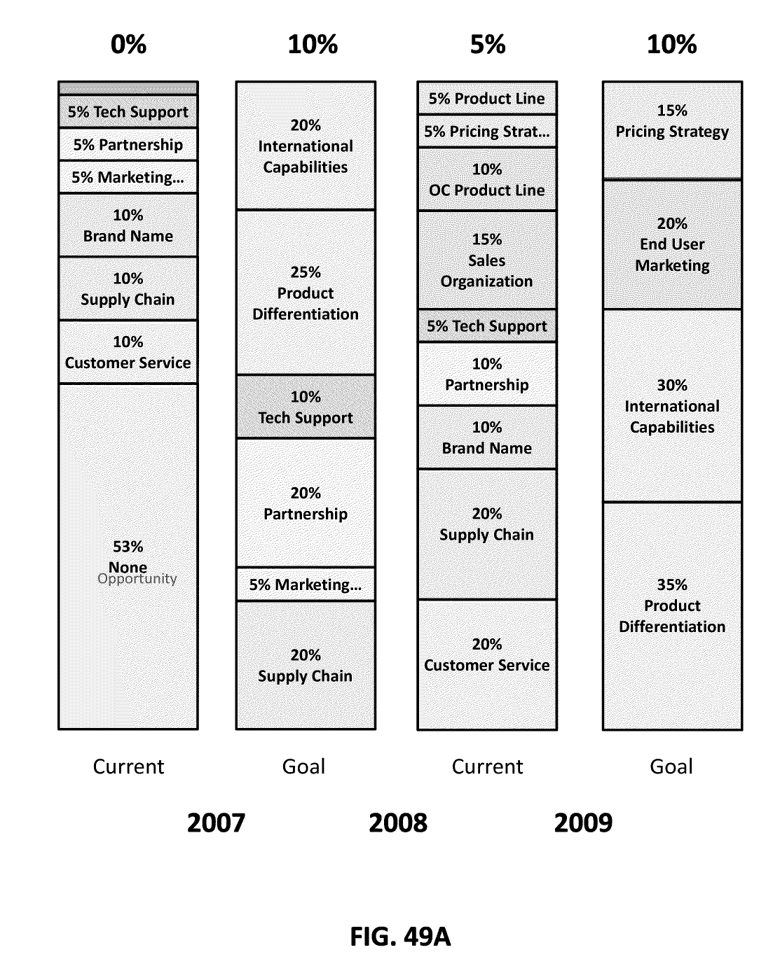

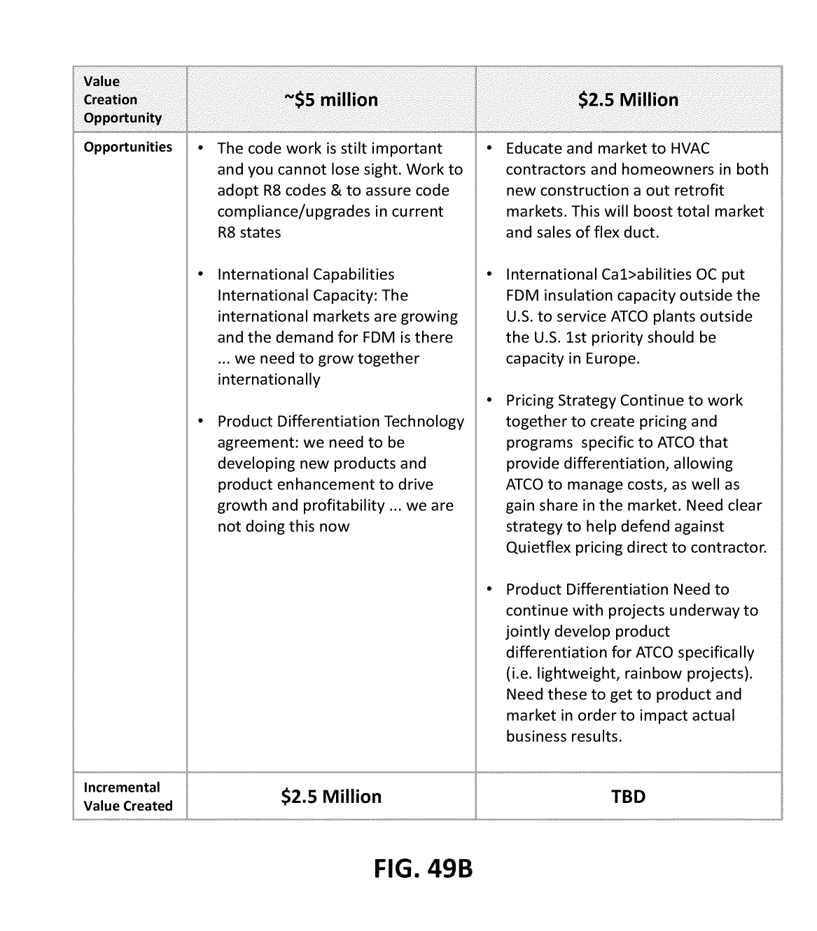

The Value Creation Dashboard combines the data collection effort in the Gather/Discover and Measure modules to create a dashboard that measures the quantified value creation progress across multiple dimensions, from an individual customer to across the entire dataset or many customers. It tracks ongoing customer economic needs and value creation progress over the course of time in a manner quantified in terms of a customer's economics (see FIG. 49). This dashboard may be built entirely from the customer's perspective.

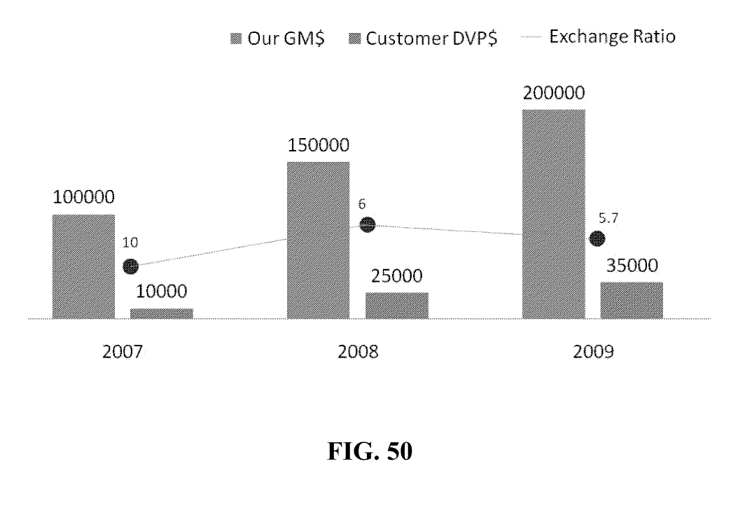

The Value Capture Dashboard tracks the correlation between customer value creation and an organization's ability to capture its fair share. It combines traditional internal data streams with the data collection efforts in the Gather/Discover and Measure modules to use value creation as a leading indicator to financial performance. At the core of this dashboard is the correlation between the quantified DVP and an organization's gross margin (GM) dollars on its products and services. FIG. 50 shows a historical view of an organization's GM dollars as compared to customer DVP, and the exchange ratio, which is GM divided by customer DVP.

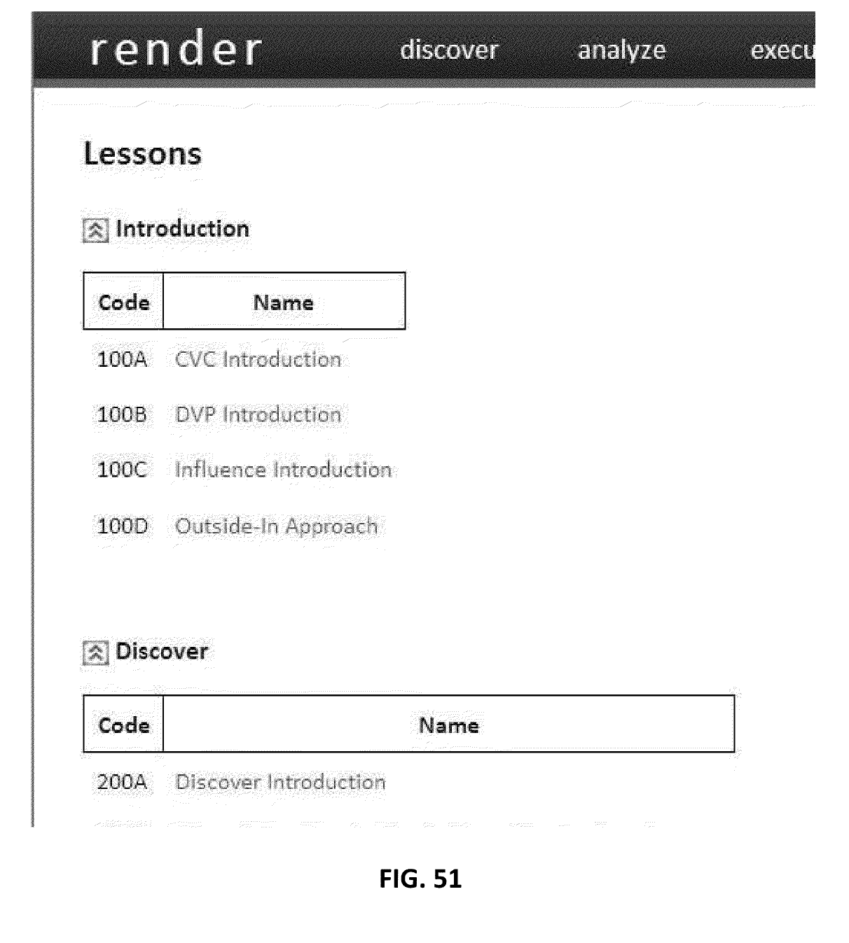

Certify: The Certify module ensures the CVC system and modules are executed with rigor through a combination of education, organizational structure, resources, and measurable change management. The confluence of the Certify module with the other CVC modules is what transforms Customer Value Creation from a project to an organizational capability. The Integrated Education Platform/Curriculum comprises training and developing qualified resources to be available to execute processes on a daily basis, driving adoption into the organization's culture. It also may comprise increasing visibility and efficiency across organization, and implementing qualification measurements (e.g., certification of interviews, analysis, action plans, and the like). It further may comprise accessing, defining, developing, deploying, and measuring a training program, and establishing a level of compliance/results standards (e.g., certification milestones recognition such as black belts for Six Sigma). As seen in FIG. 51, an integrated set of online and offline training lessons may be offered to certify users on each step of each CVC Module, so that execution is rigorous and can be owned by an organization.

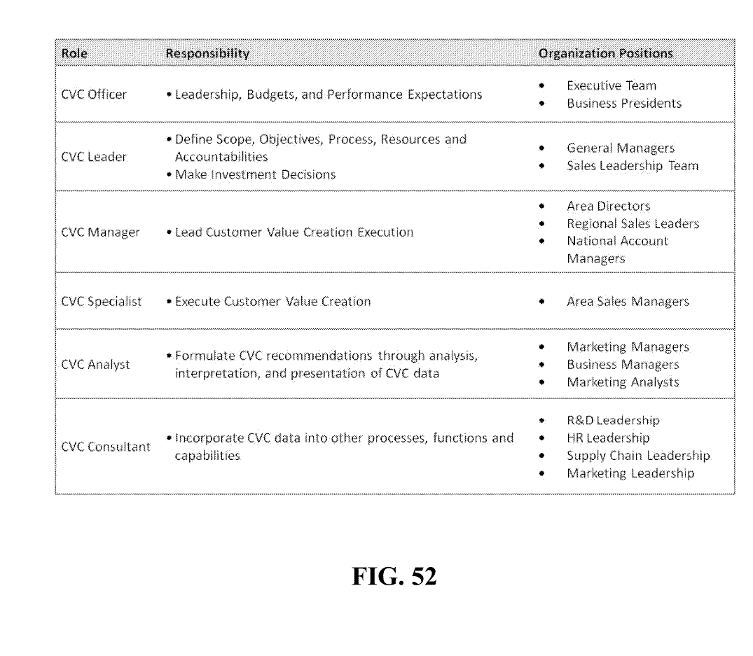

In the Roles & Responsibilities process, as seen in FIG. 52, organizational positions are translated into CVC Roles & Responsibility element to drive accountability. This process comprises designing and developing roles and responsibilities to support institutionalization, and considering requirements for business continuity, project execution and support functions. It further comprises mapping roles and responsibilities to tailored processes, clearly defining roles and responsibilities to allow the organization to update job descriptions and clearly communicate critical outcomes, and designing the organization to have the capacity to execute, control and influence, and to have access to required budget.

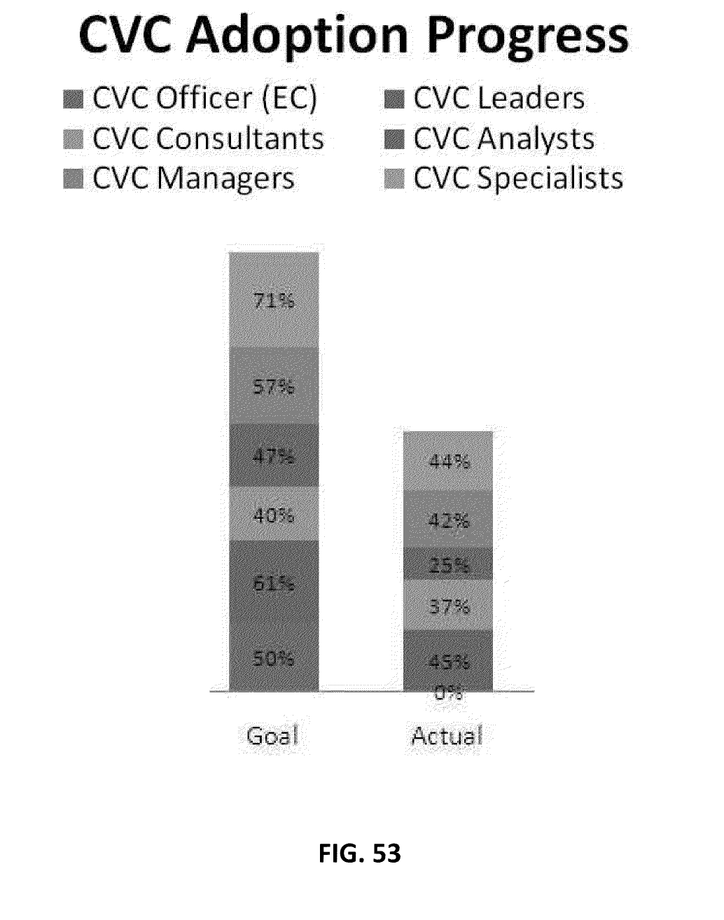

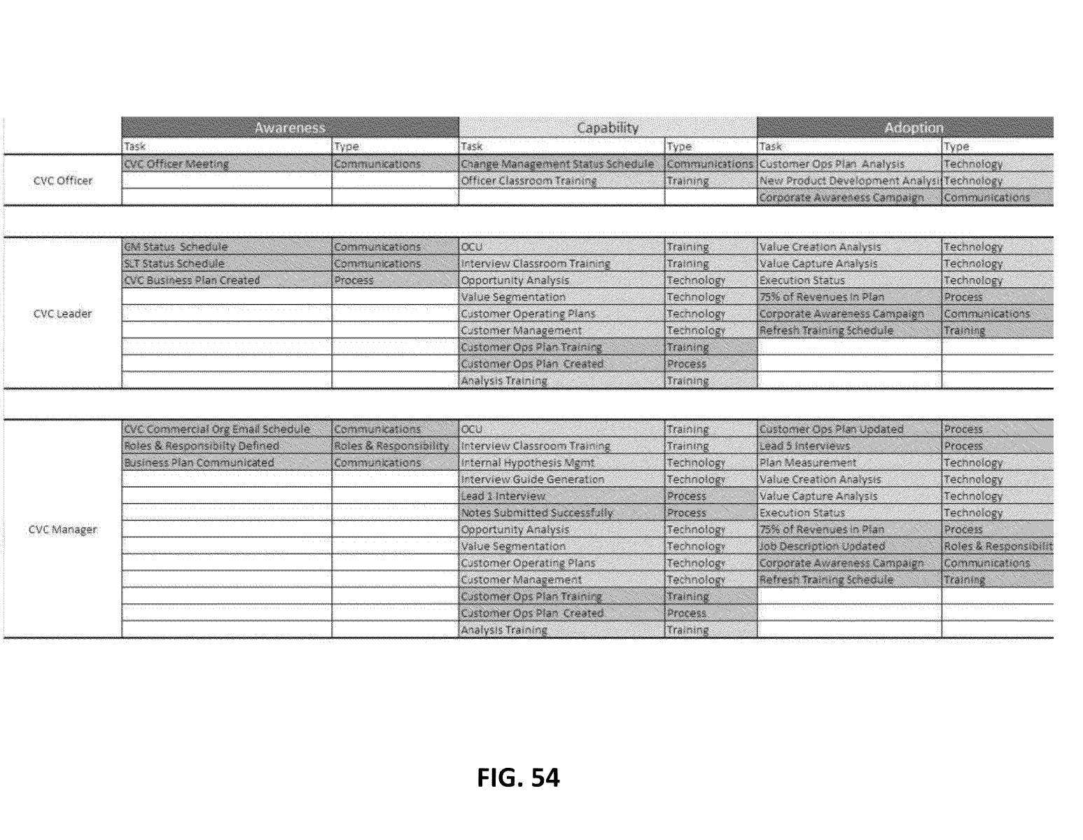

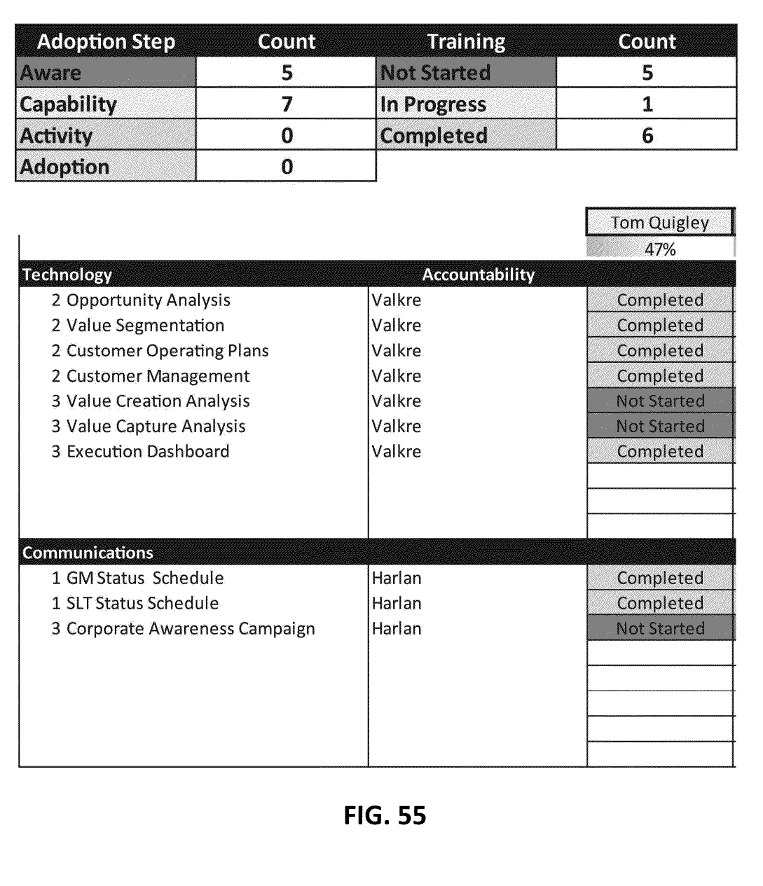

The Measurable Change Management process comprises the measurement of the execution of the CVC modules so that the CVC Dataset is rigorous and unbiased. Each action in each CVC module can be measured (see FIG. 53), which provides the mechanism to measure and manage change. Each user is assigned a list of change management milestones, based on their role in the organization (see FIG. 54). CVC change is proactively managed by tracking progress against their role milestones (see FIG. 55).

The Communications process comprises providing tools and documents necessary to communicate the purpose, status, and results of Customer Value Creation to both the client organization and its customers to spur adoption, and increasing customer participation and level of engagement, as well as increasing internal awareness. One goal is to become a strong voice for a market-driven organization, and access, design, develop, deploy, and measure a communication program. It also may comprise developing presentation collaterals, and establishing newsletters and monthly and quarterly reports distributions.

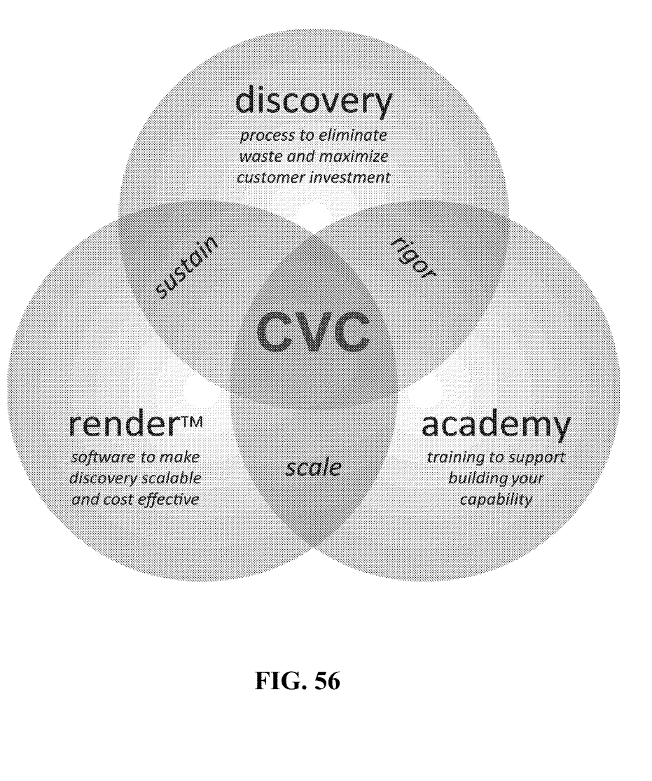

In one embodiment, the system encompasses the Customer Value Creation (CVC) Product Suite. The CVC Product Suite is an integrated computer-based platform of three tools: Discovery (The Process); Render™ (The Software); and Academy (The Education). These products enable an organization to own and manage the CVC dataset and the CVC Approach and modules without the reliance of third party subject matter experts or the dependency on a team of high-cost analysts to manage Customer Value Creation. Instead, these products serve as the vehicle for transferring the CVC process and system to an organization. FIG. 56 shows the CVC Product Suite of an exemplary embodiment of this component of the present invention. At the highest level, the primary factor of differentiation for the CVC Product Suite is the ability to transfer intellectual property through the Discovery Process, the Render™ computer software program, and the Academy Training Curriculum.

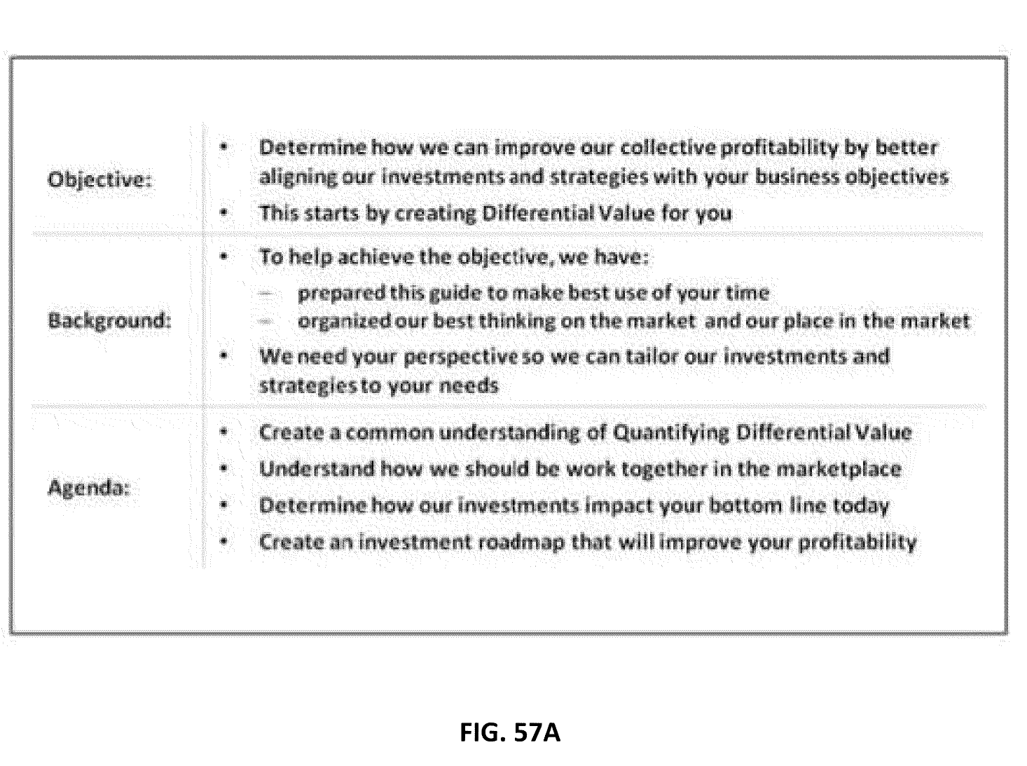

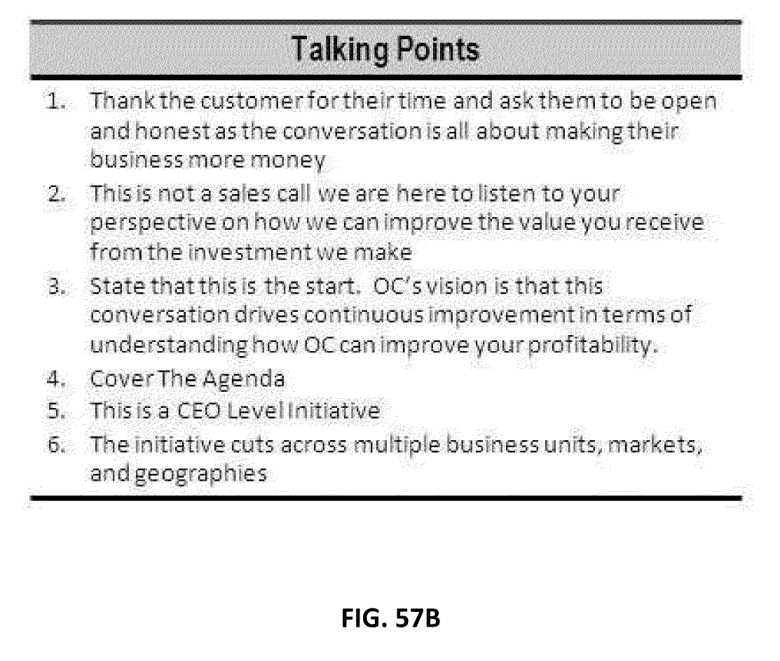

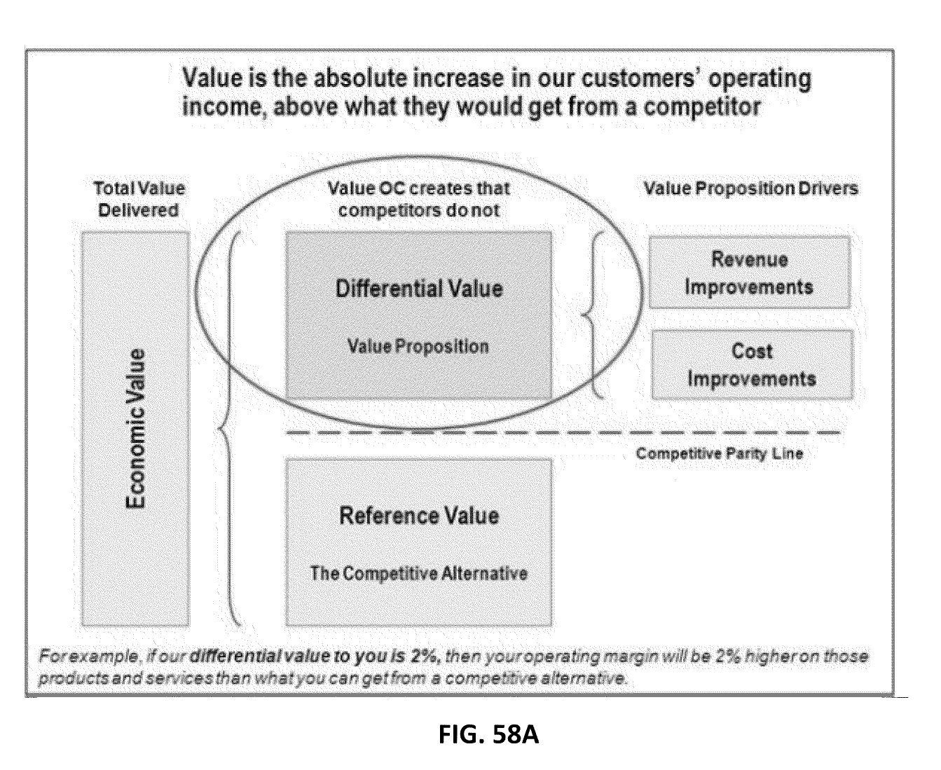

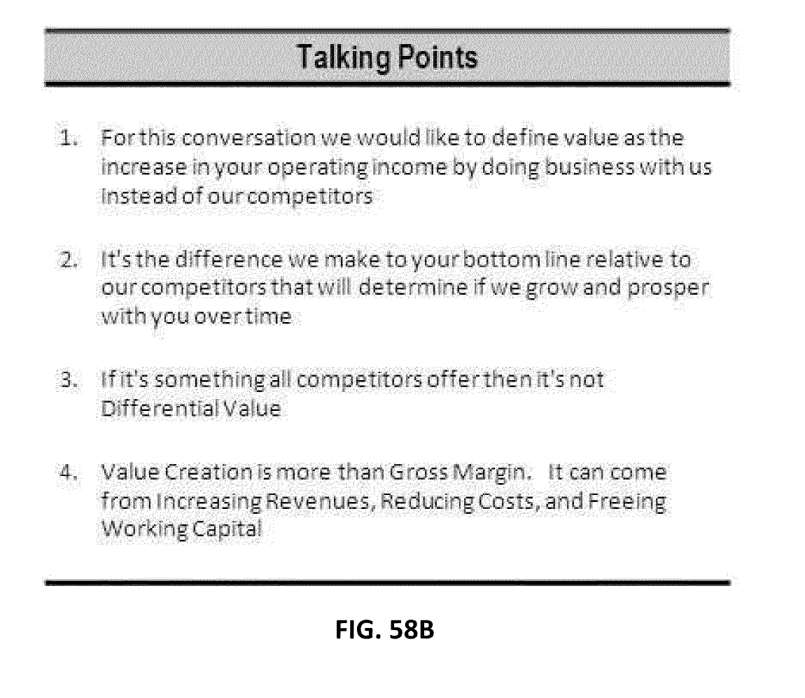

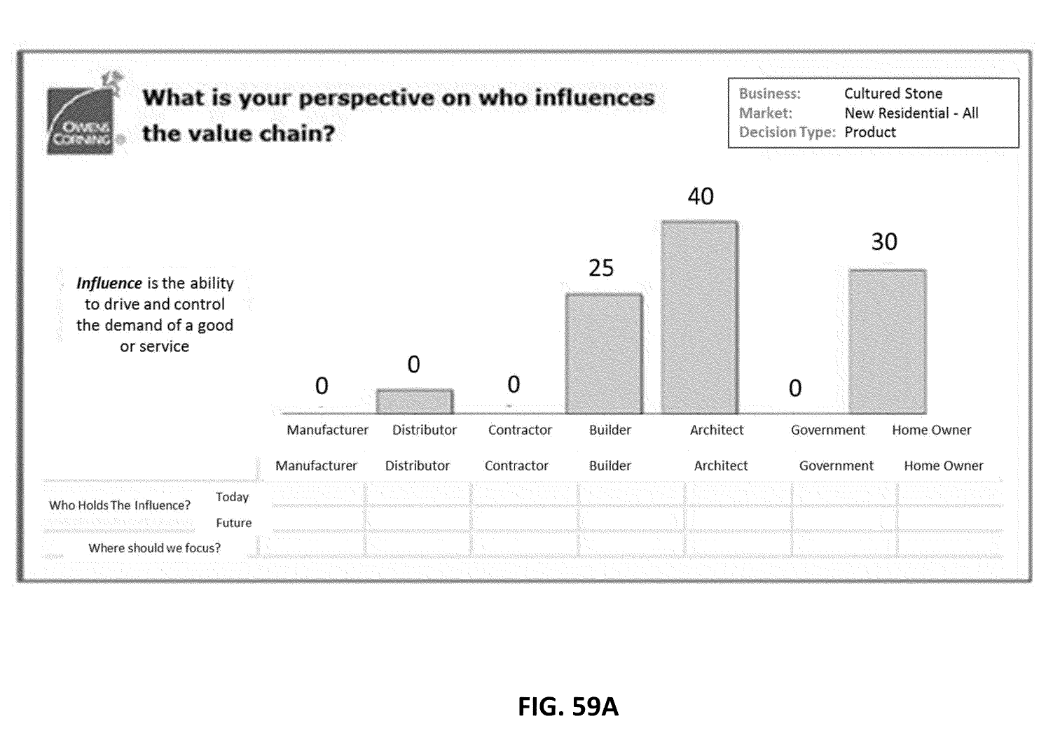

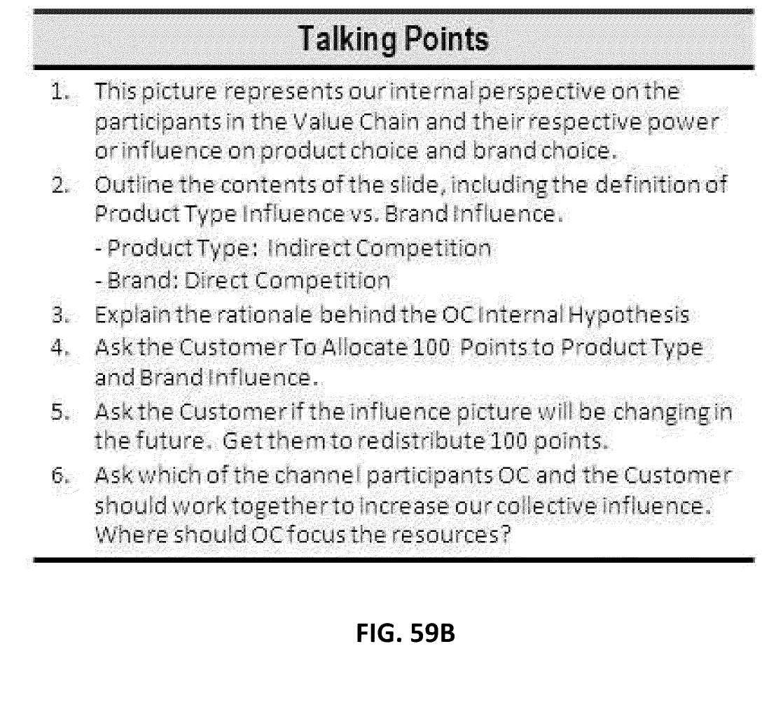

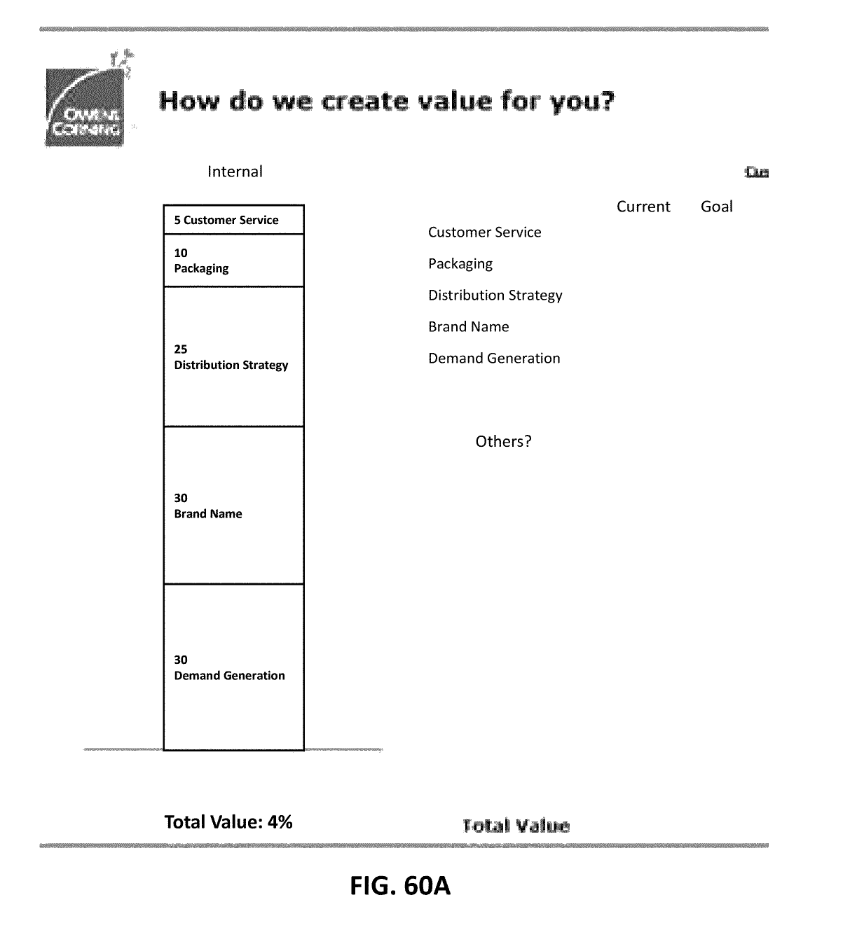

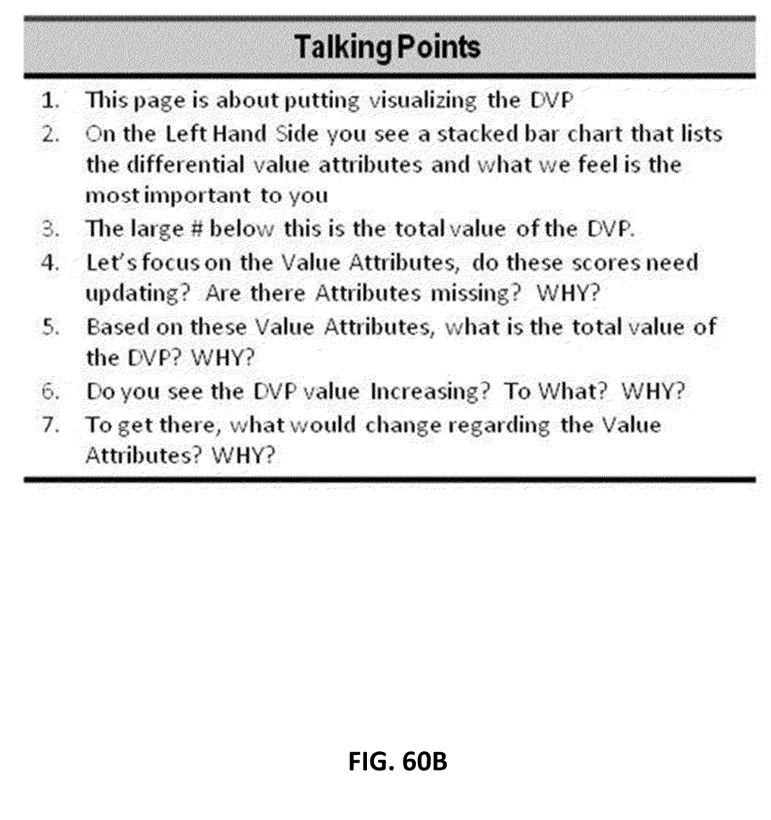

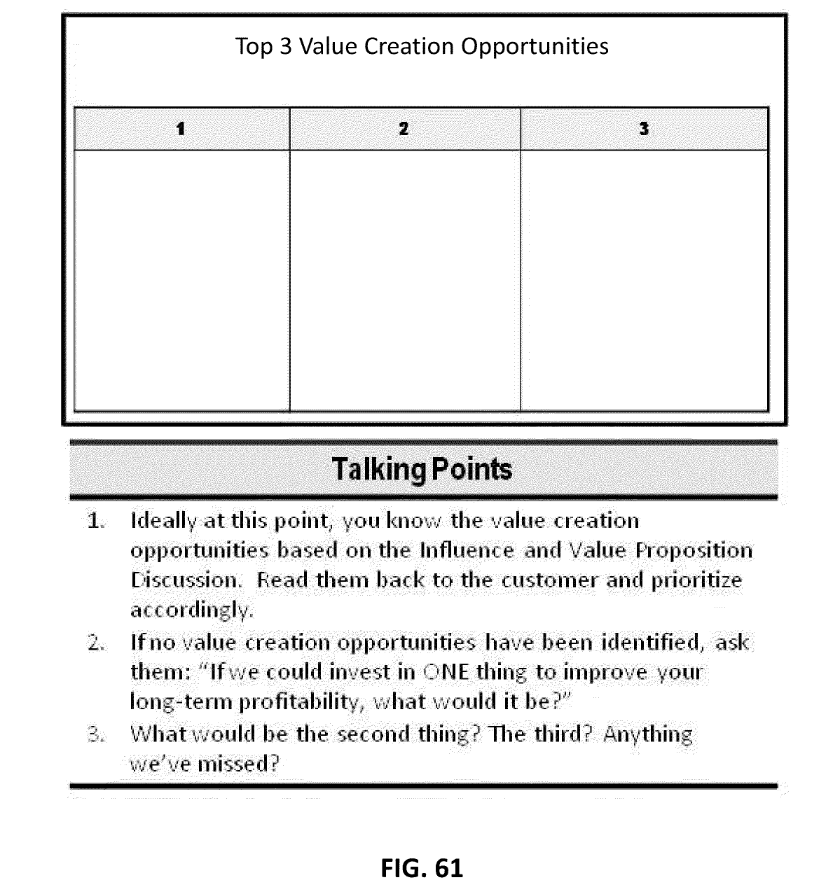

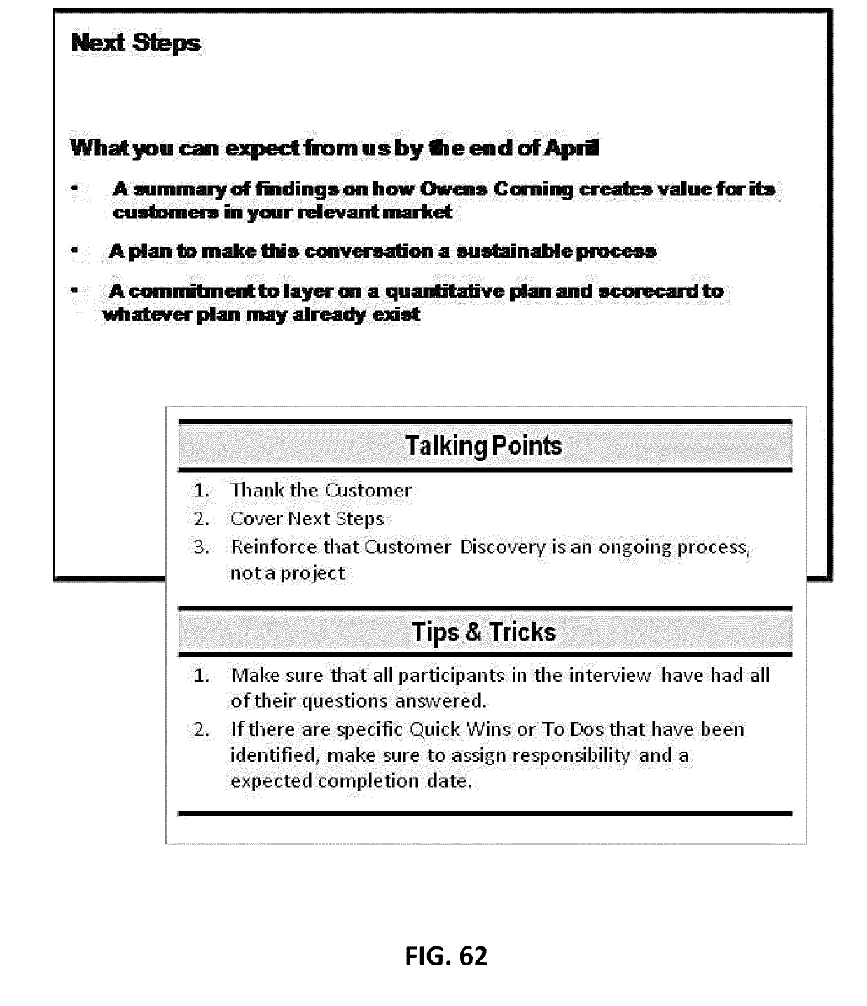

The Discovery Process comprises structured customer interaction to extract the customer's perspective on customer value creation as described in sections of the Gather/Discover and Measure modules. The Discovery Process is the primary data collection methodology in Customer Value Creation and therefore is the catalyst for completing the CVC dataset and executing the CVC Approach. The Discovery Process includes 6 steps, as shown in FIGS. 57-62: educating and engaging the customer; defining Differential Value; collecting the current, future, and focus Demand Influence data; collecting the Differential Value Proposition data; collecting the Opportunity data, and properly setting expectations with the customer. The Discovery Process may be executed via in-person interview, telephone interview, online webinar, or various survey methods. The Discovery Process is structured such that customers and organization employees can understand and contribute to the CVC dataset without reliance on professional consultants or excessive training

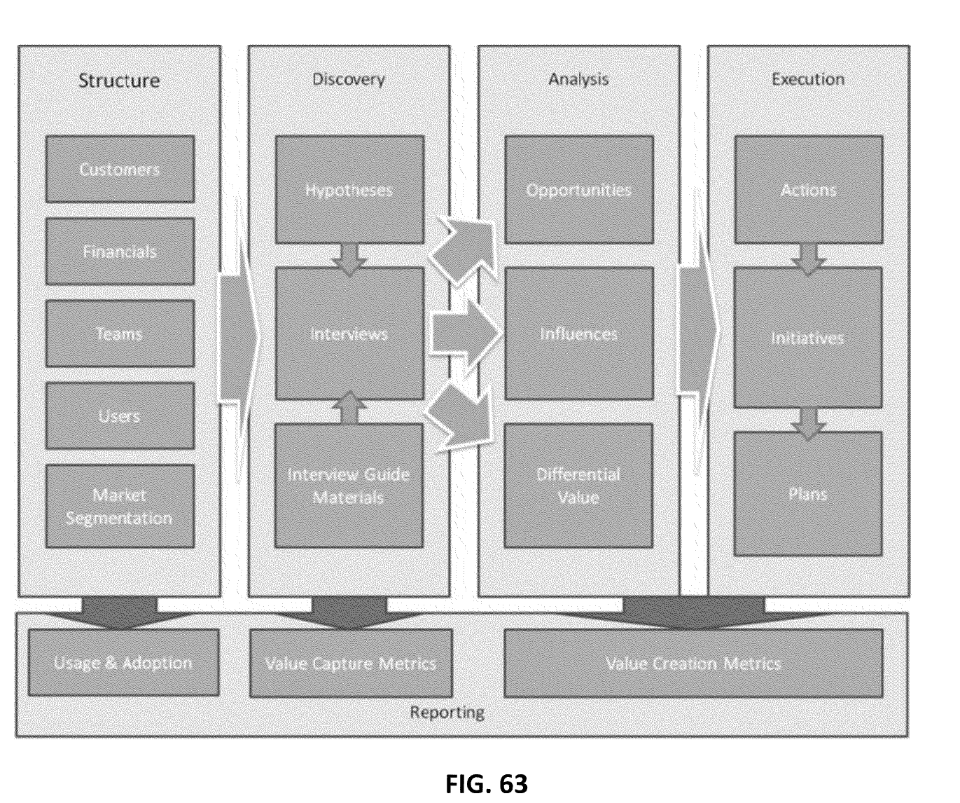

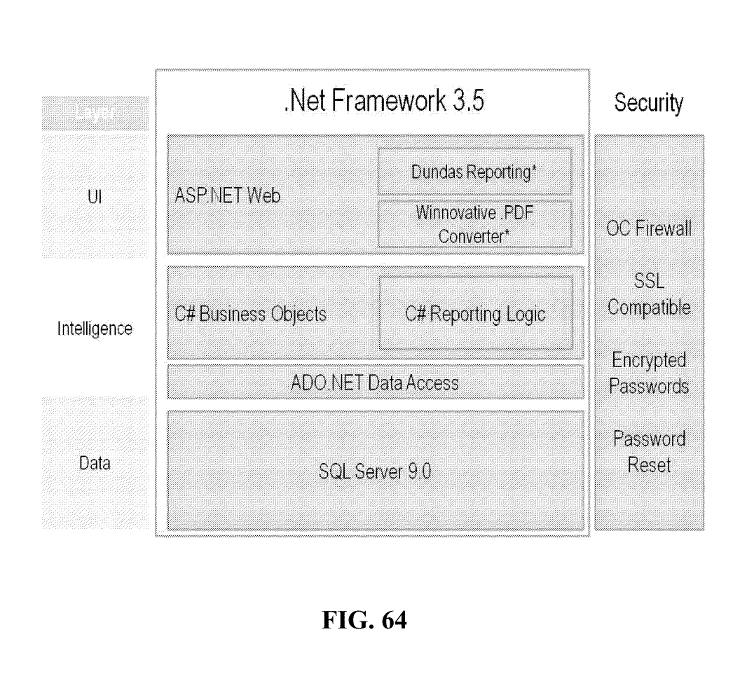

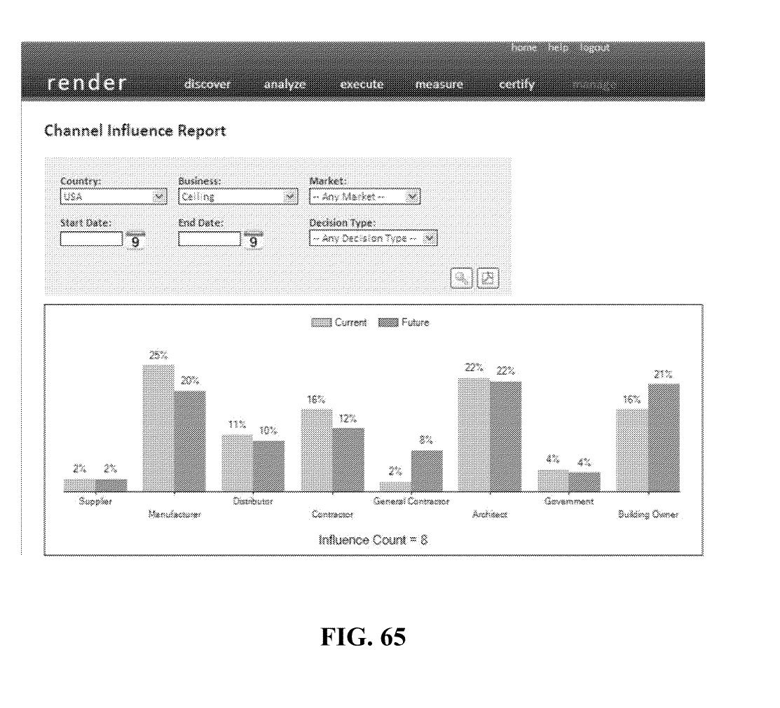

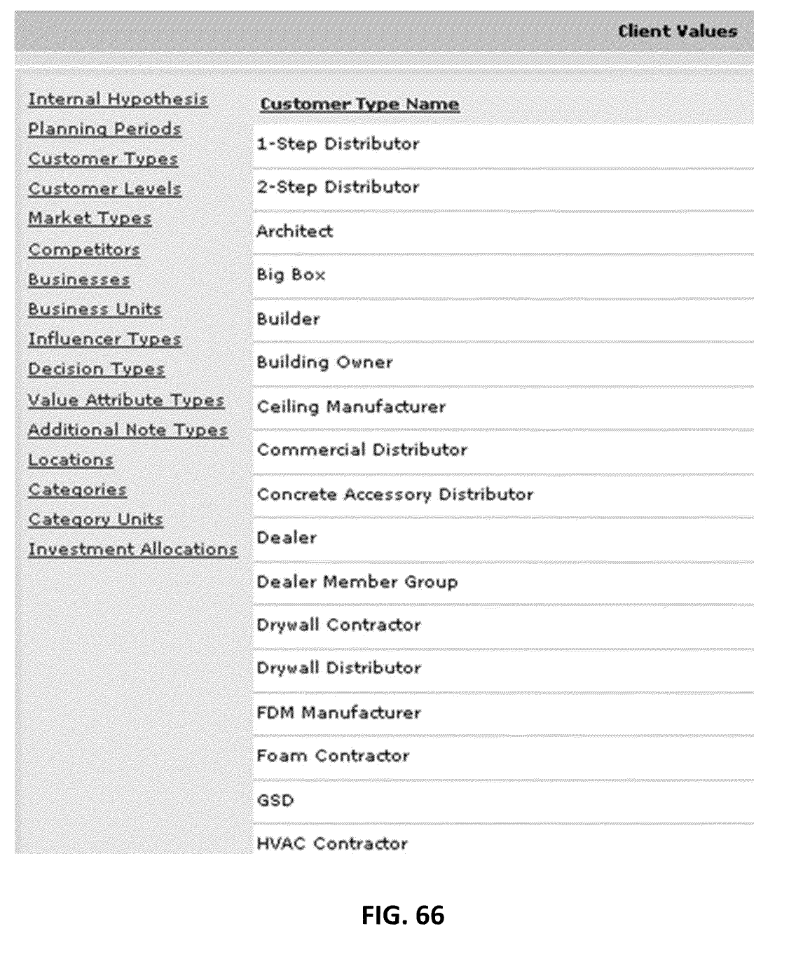

The Render™ software is a web-based computer software program that enables organizations to manage Customer Value Creation in an efficient, effective and affordable fashion such that the organization can own a Customer Value Creation capability. The Render™ computer software program comprises: (1) Render™ Database: this comprises a data schema that houses the CVC dataset such that the CVC Approach and Modules is executed in an integrated fashion; an exemplary embodiment of a data schema design is shown in FIG. 63. (2) Render™ Application: this comprises computer code on computer-readable media, a graphical user interface, and a navigation taxonomy that brings the CVC Approach and modules to life for an organization. The Render™ software application guides users through the CVC Modules in an easy to use fashion that requires minimal training and administration. In one embodiment, the software application is designed as a software-as-a-service delivery model, built on a development platform such as Microsoft .NET, as shown in FIG. 64. It contains all of the CVC modules in its code set, accessible by an easy-to-use web-based graphical user interface, an example of which is shown in FIG. 65. (3) Render™ Shell: this comprises an application shell that allows Customer Value Creation to be tailored to an individual organization's business and needs without requiring additional software application development (see FIG. 66). All customization can be performed by an administrator, allowing deployment to be completed more quickly. In one embodiment, the Render™ Shell comprises a metadata platform that allows organizations to specify the businesses, customers, markets, channels, and all other dataset nuances by an application administrator requiring no prerequisite skill set aside from basic computer use proficiency. The Render™ Application Shell also includes the ability for organizations to customize access to CVC dataset and CVC Modules by user role and responsibility.

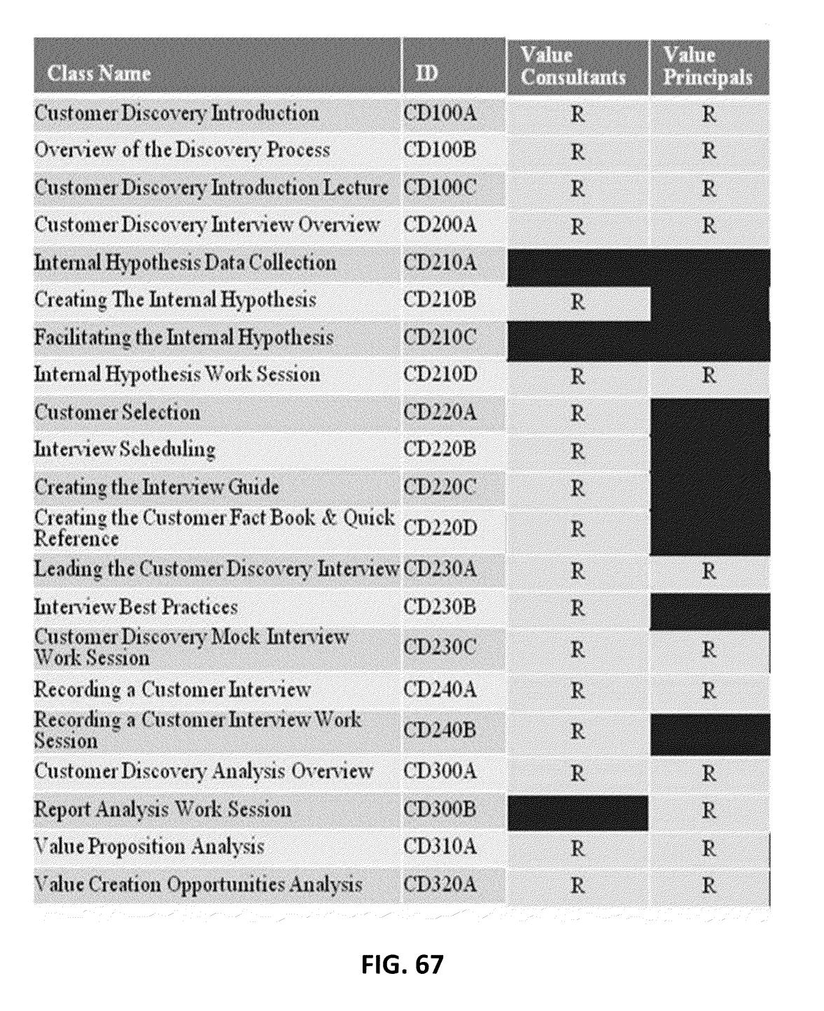

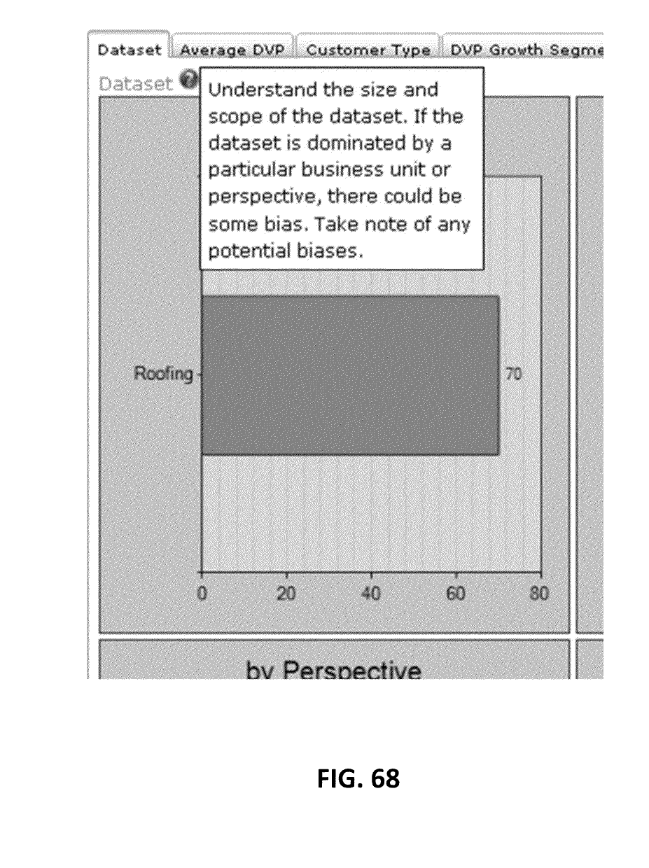

The Academy Training Curriculum comprises an integrated system of online computer based training lessons, in-person classroom workshops, and application tool tips so that organizations can execute the CVC Modules with rigor. An example of a Class Catalog Matrix is shown in FIG. 67. Academy is customized by user role and deployed by first providing students with the opportunity to study and learn on their own time with computer based training Once the self-study training is complete, students then complete in-person workshops to practice and receive feedback on critical activities of CVC, such as the Discovery Process. Finally, integrated in Render are tool tips that reinforce the skills acquired in online and offline training, as shown in FIG. 68. The result is transforming a given student from no prior knowledge of Customer Value Creation to a self-sustaining practitioner of CVC in less than 2 days time.

In order to provide a context for the various computer-assisted or computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed herein, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, network PCs, minicomputers, mainframe computers, embedded systems, distributed computing environments, and the like.

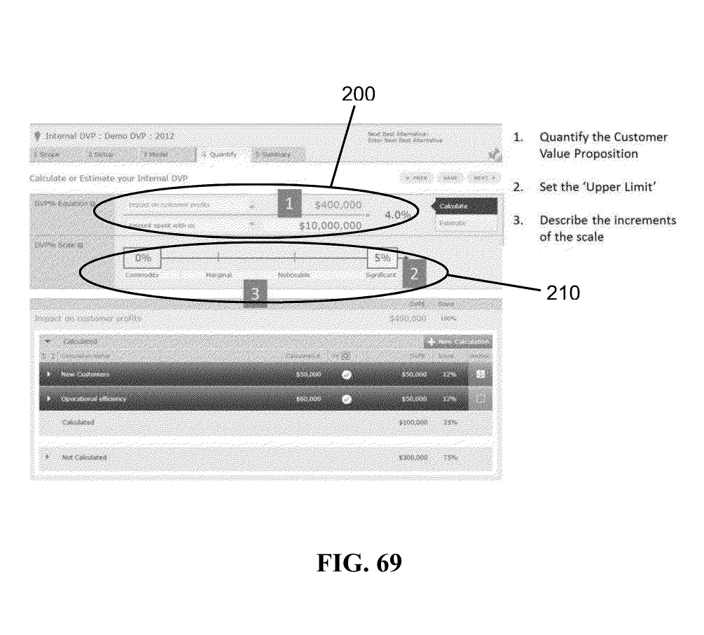

FIG. 69 depicts an illustrative screenshot of an internal Differential Value Proposition percentage (DVP %) calculation including generation of a qualitative DVP % scale in accordance with another embodiment of the invention in the Gather/Discover module. As shown in FIG. 69, an organization may utilize the computer program to calculate an internal DVP % as described above with reference to, for example, FIGS. 1 and 3. For example, as indicated at 200 in FIG. 69, the DVP % may be calculated as the total economic impact, in operating margin dollars, that the organization has on a particular customer's bottom line, divided by the amount of money the particular customer spends with the organization to buy, use, or interact with its products or services. For example, DVP % may equal the profit that the organization's DVP contributes, divided by the amount of products or services the customer buys or uses from the organization. For example, if the impact on customer profits is $400,000, and the total amount of money spent by the customer with the organization is $10,000,000, then the DVP % will be 4%.

The DVP % as a numerical value, however, may be a purely quantitative indicator that may not otherwise intuitively convey to the user the economic impact that the organization has on the customer's bottom line relative to the organization's competitors or next best alternative. For example, a DVP % of 4% may indicate great value to one customer in a particular market or industry (e.g., software or high tech) relative to the organization's competitors. On the other hand, for another customer in a wholly different market or industry (e.g., biotechnology), a DVP % of 4% may not indicate the same level of value relative to the next best alternative. Thus, while higher percentages invariably indicate relatively greater importance of the organization to the customer, a simple qualitative indicator may be useful in preparing for the customer interview portion of the Gather/Discover module.

As shown in FIG. 69, a qualitative DVP % scale 210 may be created and utilized by the organization to more readily and clearly indicate the economic impact that the organization has on the customer's bottom line relative to the organization's competitors or next best alternative. The qualitative DVP % scale 210 may be created and/or formatted by a user during a setup portion of the internal DVP % in the Gather/Discover module and may provide a benchmark to visually indicate whether the calculated economic impact is large or small on the customer based on common standards in the customer's market/industry. For example, during set up, the user may define the parameters of the qualitative DVP % scale 210 by entering a lower quantitative limit (e.g., zero %) and/or an upper quantitative limit. Alternatively, the lower quantitative limit may be set at zero %, for example, by default. The user may also provide a number of increments on the scale 210 and/or descriptions (labels) of the increments of the qualitative DVP % scale 210. For example, as shown in FIG. 69, the scale 210 has a lower limit of zero %, an upper limit of 5%, and is divided into three segments having four total increments (the lower limit, two mid-range indicators, and the upper limit). The increments on scale 210 are shown as having the labels “Commodity” (lower limit), “Marginal” (lower mid-range increment), “Noticeable” (upper mid-range increment), and “Significant” (upper limit). The scale 210 is not limited to the depicted limits, number of segments, and/or number of increments and any useful descriptions (labels) may be utilized, either as selected from a limited menu of available options or manually inputted by the user during a setup process. For example, the scale 210 may be modified and/or created by the user based on the particular market or industry in which the customer operates. The user may, for example, adjust or modify the features of the scale 210 accordingly based on prior experience, preference, and/or internal market and industry research.

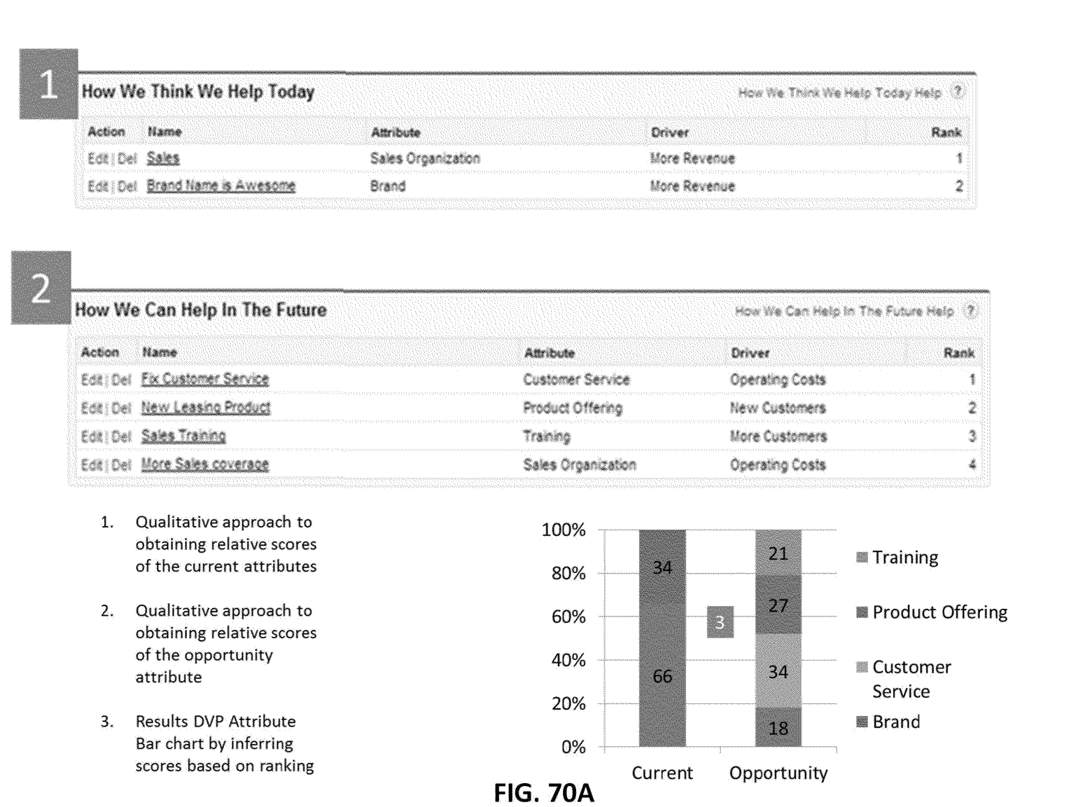

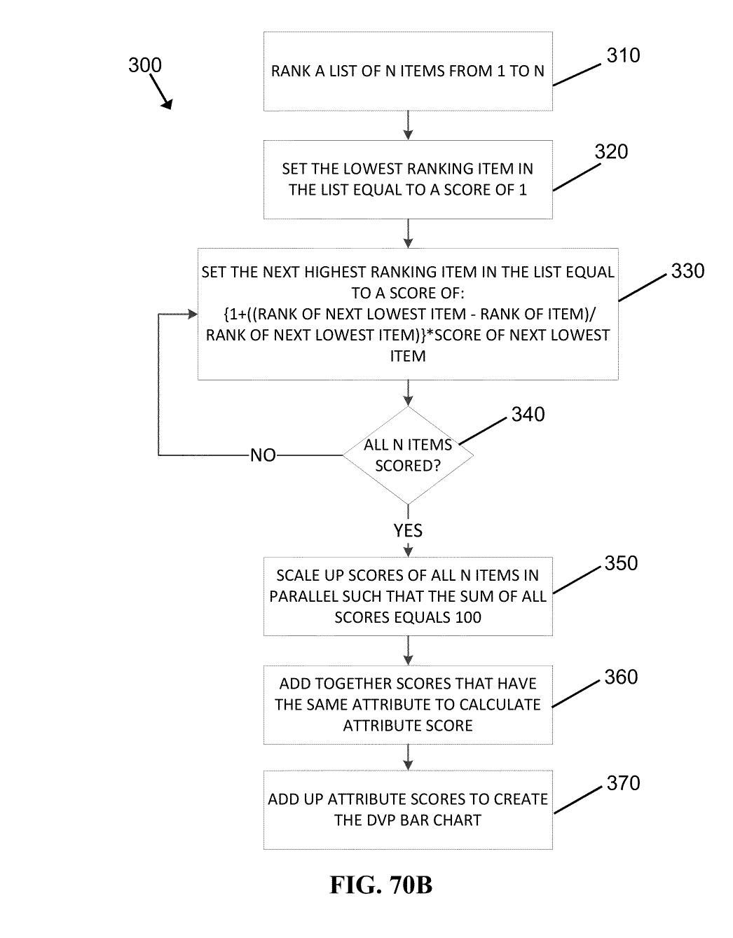

FIG. 70A depicts an exemplary screenshot of a simplified qualitative Interview Guide or template generated and completed in accordance with another embodiment of the invention in the Gather/Discover module. As shown in FIG. 70A, a user may complete the DVP Internal Hypothesis in a similar but modified fashion to the methodology employed above with reference to FIGS. 8-10. The modified methodology may provide a more qualitative approach to obtaining relative scores of current and future (opportunity) attributes by inferring the scores from a simple ordered ranking and outputting the inferred attribute scores in a visual manner such as, for example, in a DVP Value Attribute bar chart or the like. The qualitative Interview Guide may simplify the customer interview by, for example, providing a bottom up approach which may offer an exemplary way to get at the same data without digging into quantitative details as much during interview with customer. For example, the user may identify and enter one or more current Value Attributes for the customer and numerically rank the one or more current Value Attributes. Current Value Attributes may be derived or identified based on the user asking the question “How do we think we help [the customer] today?” Once the current Value Attributes are identified, rather than manually giving each current Value Attribute a score, the program allows the user to simply rank the current Value Attributes in order according to perceived importance to the customer's bottom line as indicated at 301. The program then applies an algorithm, described in further detail below with reference to FIG. 70B, to convert the ranked list of current Value Attributes into inferred scores for the current Value Attributes as indidated at 302.

Furthermore, as shown in FIG. 70A, the user may identify (e.g., list) future Value Attributes (opportunities) of greatest value and/or concern to the customer. Future Value Attributes may be derived or identified based on the user asking the question “How can we help the customer in the future?” Then, the user may again simply rank the future Value Attributes in order according to the relative importance to the customer's bottom line as indicated at 303. The program then applies the algorithm described in further detail below to convert the ranked list of future Value Attributes into inferred scores for the future Value Attributes as indicated at 304. Once the DVP Internal Hypothesis is complete and the scored Value Attribute data is collected, it may be entered into and stored in a system database. The information may be stored in a standardized format such that it can be compiled and combined with other customer perspectives.

FIG. 70B depicts an exemplary flow chart 300 illustrating the algorithm for converting a ranked list of Value Attributes into inferred scores for the Value Attributes in accordance with an embodiment of the invention. As shown in FIG. 70B, an example algorithm or transfer method which may be utilized to convert ranked lists of items to attributes, each having a relative inferred score. After ranking a list of N items from 1 to N (Block 310), the algorithm may include the steps of: setting the lowest ranking item in the list of N items equal to a score of 1 (Block 320); setting the next highest ranking item in the list equal to a score of

$$[ 1 + \frac{( Rank of Next Lowest Item - Rank of Item )}{Rank of Next Lowest Item} ] \times Score of Next Lowest Item ;$$

(Block 330) and continuing to score Items in the order of their ranking until all items are scored (Block 340). If Items have similar rankings, they may be given similar scores. Once all Items are scored, the scores may be scaled up in parallel such that the sum of all scores equals 100 (Block 350). Then, by adding together Item scores that have the same Attribute, the Attribute Score is determined (Block 360) and may be output, for example, by creating a visual or graphical representation such as, for example but not limited to, a DVP Bar Chart (Block 370) as shown at 302, 304 in FIG. 70A. Referring to ranked list 303 in FIG. 70A, for example, the list may include four items (Customer Service, Product Offering, Training, and Sales Organization) ranked 1-4. Based on the above-referenced algorithm, the Scores of each item are calculated based on the rankings and a scaled up Attribute Score (% of Total) may be determined as shown in FIG. 70A at 304 as well as in Table 1 below.

TABLE 1

| | | | % of |
|---|---|---|---|
| | Rank | Score | Total |
| Customer Service | 1 | 2.5 | 39% |
| Product Offering | 2 | 1.666667 | 26% |
| Training | 3 | 1.25 | 19% |
| Sales Organization | 4 | 1 | 16% |

An advantage of simplifying the Interview Guide and employing the rank to attribute score conversion may be, for example, in terms of time and cost of training. For example, if the user organization has hundreds or thousands of sales people to train, employing the qualitative Interview Guide and corresponding conversion algorithm may allow the organization to maintain or increase quality of information output from salesforce while keeping training costs low.

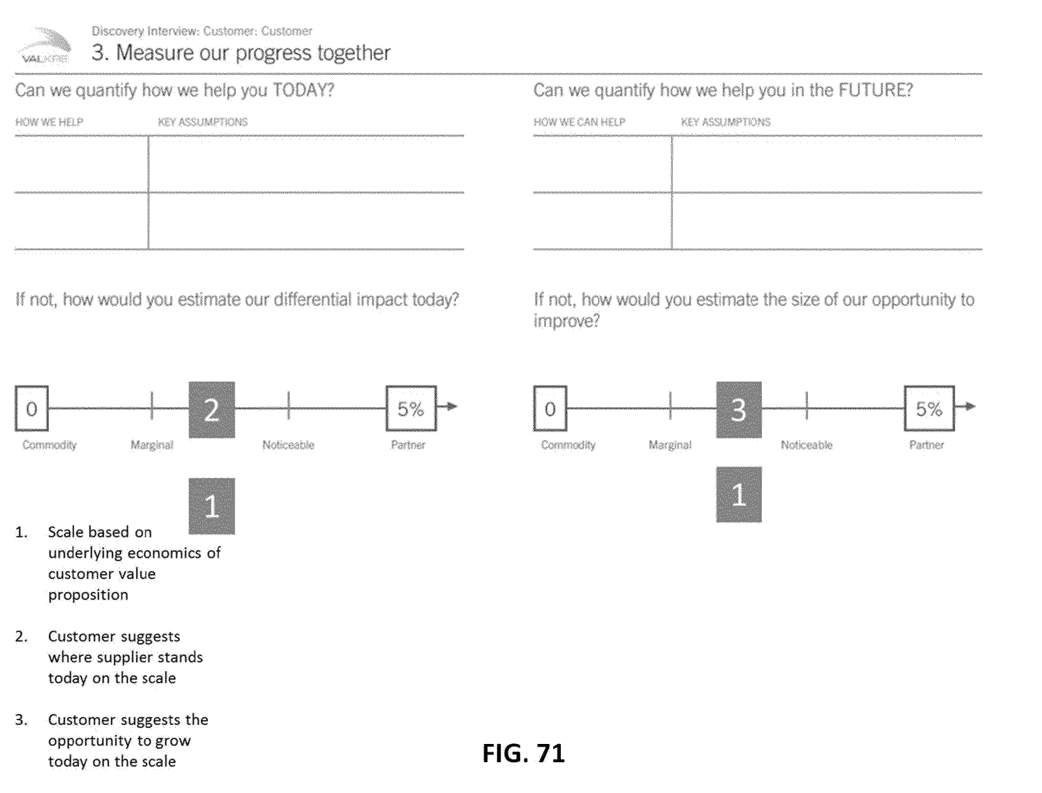

FIG. 71 depicts an Interview Guide template including the qualitative DVP % scale of FIG. 69 in accordance with another embodiment of the invention in the Gather/Discover module. As shown in FIG. 71, an Interview Guide template may include the qualitative DVP % scale 210 of FIG. 69 to estimate the value of current Value Attributes and future Value Attributes. The scale 210 may be based on the underlying economics of the customer value proposition and may provide a simple visual framework for the user to employ during the customer interview. For example, during the interview, the user can ask the customer to qualitatively estimate current differential impact as well as future differential impact (opportunity to improve). Thus, the customer can provide a qualitative answer on current impact based on the scale 210 as well as a qualitative answer on future impact based on the scale 210′. The user can correlate the qualitative responses to estimate a quantitative DVP %.

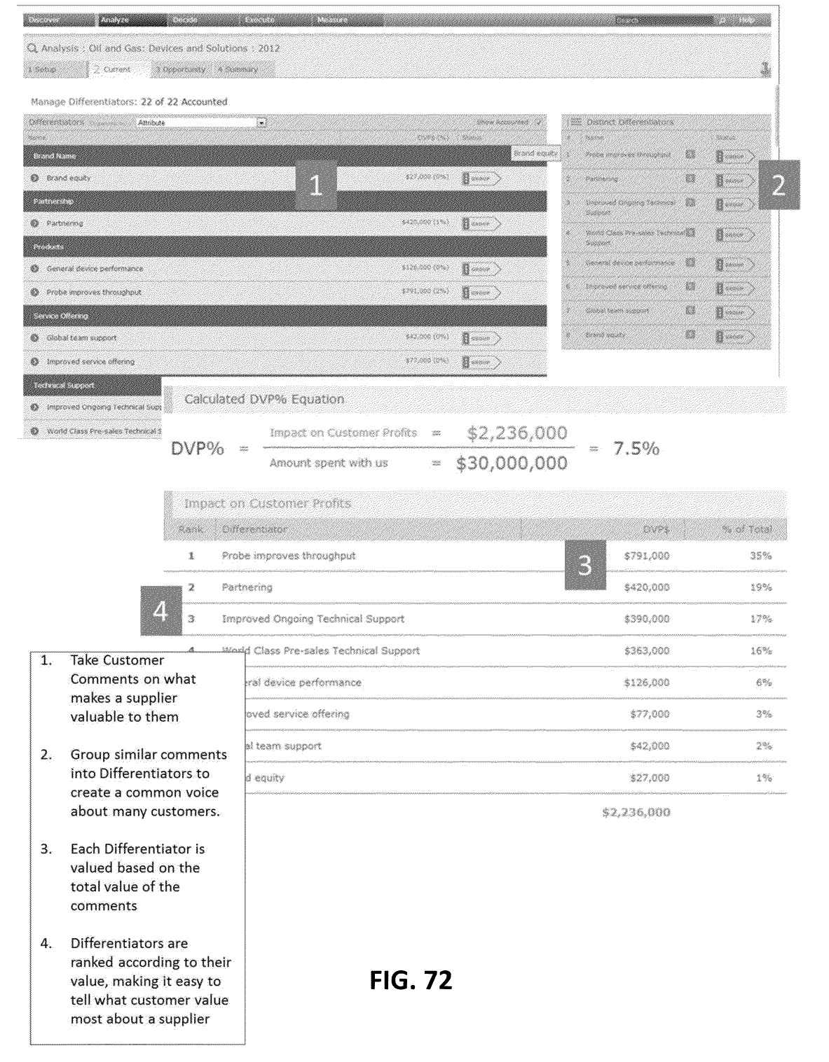

FIG. 72 depicts an exemplary screenshot showing an aggregation of comments from many customers and utilizing the aggregated comments to identify and rank primary differentiators of the organization in accordance with another embodiment of the invention in the Analysis module. As shown in FIG. 72, comments from a plurality of customers obtained through the interview process can be input into the system. The comments may include differentiators (those qualities that customers value most in the organization and which differentiate the organization from the next best alternative). The differentiators may be aggregated and similar differentiators can be grouped together, for example, to create a common voice about the organization across many customers. Each differentiator may be valued based on the total value of the comments, although other valuation methods may be possible, and the differentiators may be ranked according to their value. This may make it easy for the organization to see what customers value most about the organization in the aggregate and may be used, for example, to identify a ranked or prioritized list (e.g., a top ten) of differentiators for the organization so they can continue to invest in and focus on the opportunities associated with these differentiators, increasing the customers' bottom line and, in turn, the organization's bottom line.

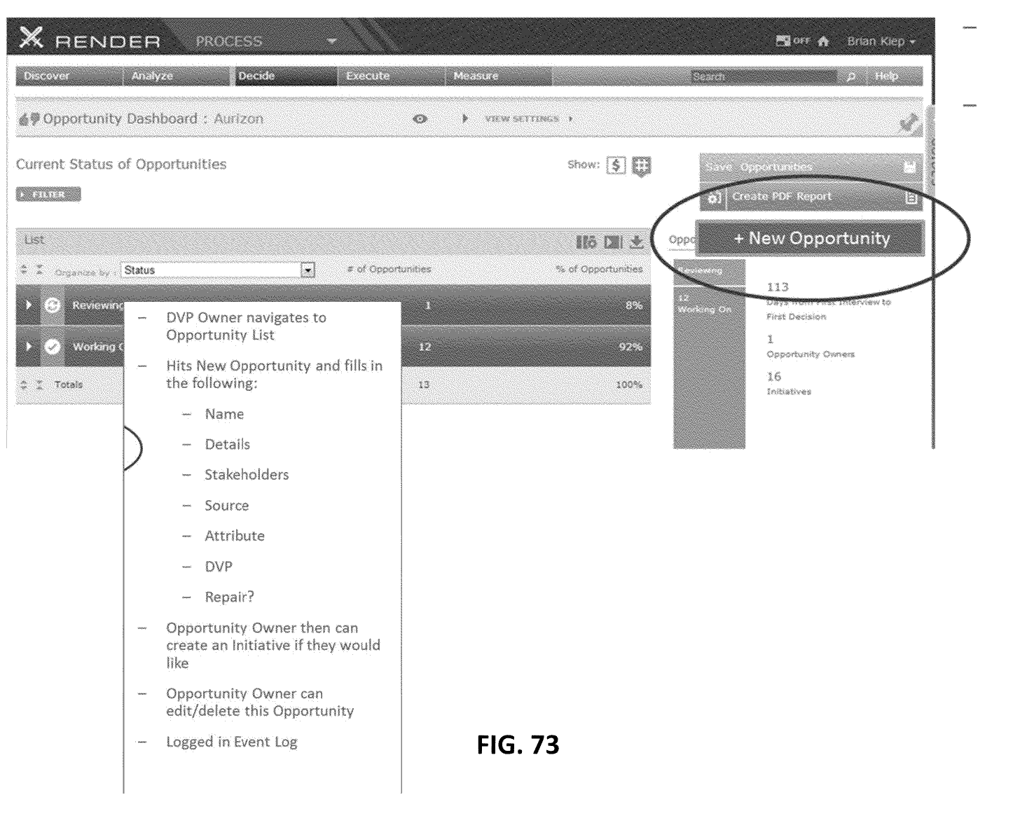

FIG. 73 depicts an exemplary screenshot showing a selectable option for allowing data entry of an identified opportunity in accordance with another embodiment of the invention in the Analysis module. As shown in FIG. 73, a selectable option titled “New Opportunity” indicated at 400 may be provided in one or more steps in the Analysis module or, alternatively or additionally, in another one of the modules. The “New Opportunity” option may provide the user with the ability to integrate sources of investment opportunities outside of the Analysis module in order to more seamlessly create assist the user in generating a comprehensive customer value creation plan. According to an embodiment, the user (DVP owner) may navigate an opportunity list, select the “New Opportunity” option, and may be required to enter information such as, for example, name, details, stakeholders, source, attribute, DVP, etc. If desired, the user may create one or more initiatives for achieving the opportunity. The user may also edit/delete the opportunity if desired.

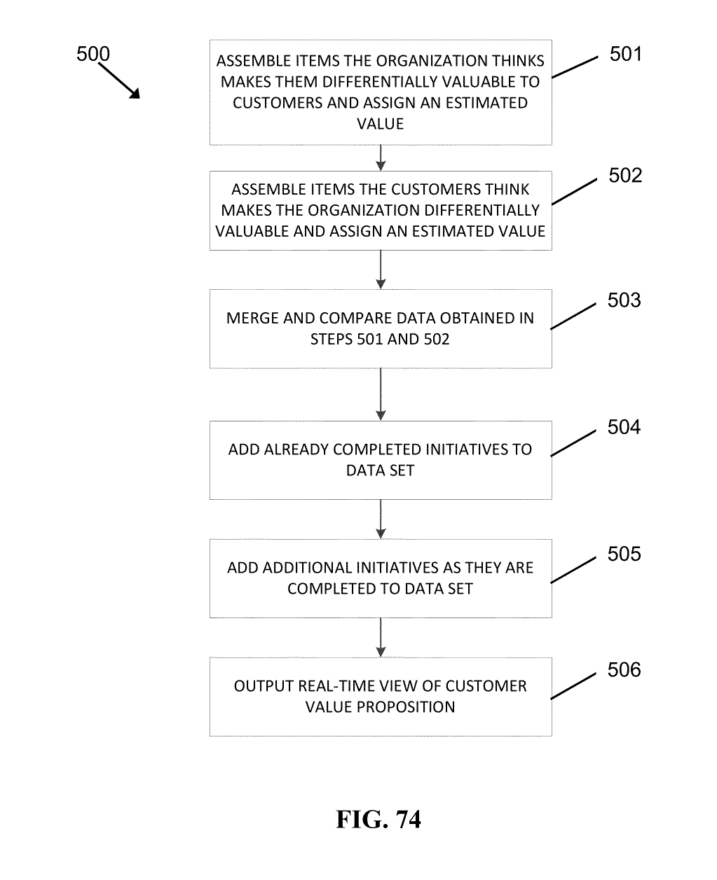

FIG. 74 depicts a flow chart illustrating a process for combining the aggregated differentiators identified and grouped in FIG. 72 with completed initiatives in accordance with another embodiment of the invention in the Execute module. Initiatives may include the action items (i.e., measurable execution items) that make up the execution roadmap for a given initiative as described above and depicted, for example, in FIGS. 41-43. As shown in FIG. 74, the process 500 for aggregating such data may provide a real-time view of the customer value proposition to the user. Having a real-time view of the value proposition may provide the user (e.g., salesperson) with information needed to ensure any sales pitch is crafted based on most up-to-date and relevant information in system.

Still referring to FIG. 74, the process 500 may include the steps of assembling what the organization thinks makes them differentially valuable to customers and the estimated value (Value Attribute) as shown in Block 501; assembling what the customers think makes the organization differentially valuable to them and the estimated value (Value Attribute) as shown in Block 502; and merging the data (Block 503) obtained in Blocks 501 and 502. The information in Blocks 501 and 502 may be obtained, for example, in the Gather/Discover module and through the internal DVP and customer interview processes described above. In the merging step 503, similar data from blocks 501 and 503 may be combined, the value of the resulting merged data can either be the value from block 501, the value from block 502, or an average of the value from Blocks 501 and 502. Listed items from Block 501 that do not match items in Block 502 may be reviewed by the user and a decision may be made to keep or delete the non-matching items. Listed items from Block 502 that do not match items in Block 501 are automatically kept since these are Value Attributes identified by the customer. The merging may be performed automatically by the system or semi-automatically with manual input from the user. In Block 504, the process includes assembling initiatives that will increase the value of the organization to the customer. As assembled initiatives are completed, they are automatically added to the dataset of Block 504 as shown in Block 505. In Block 506, an output may be provided to the user depicting a real-time view of the organizations value proposition, informed by the organization, the customer, and ongoing activity. This output may inform and improve the effectiveness of all active sales and marketing efforts.

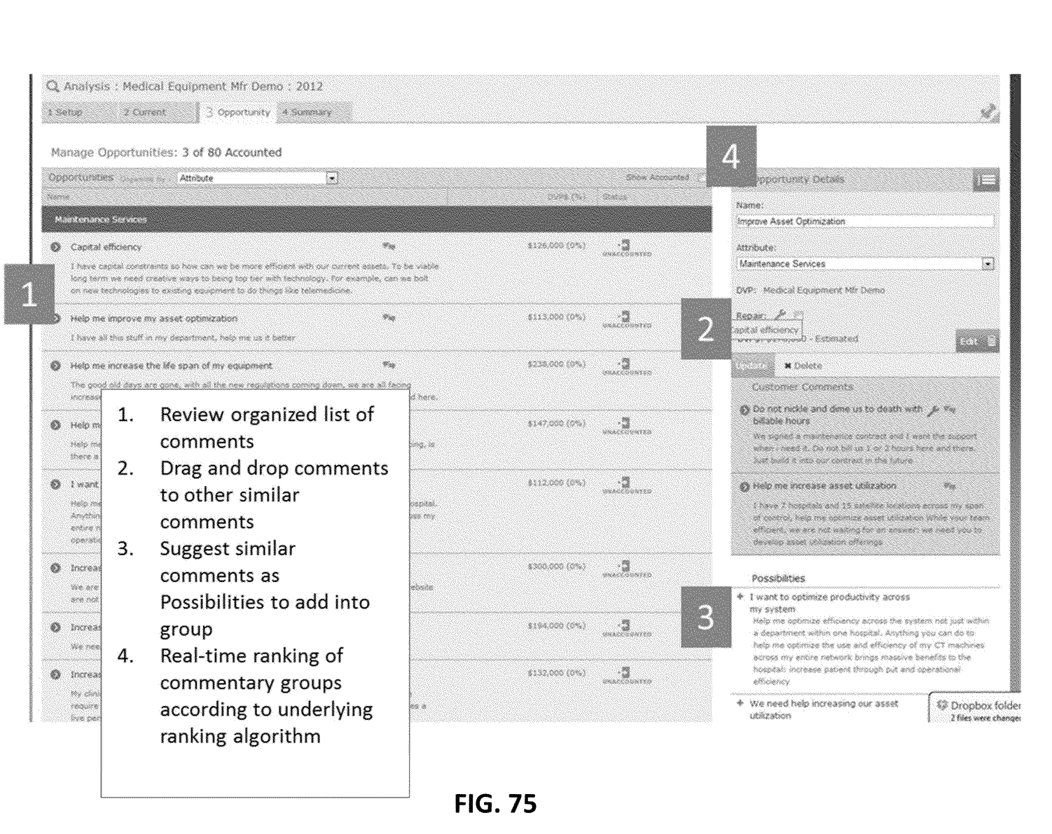

FIG. 75 depicts an exemplary screenshot depicting a system for processing qualitative customer comments in accordance with another embodiment of the invention in the Analysis module. As shown in FIG. 75, a main list 610 of all customer comments (unprocessed) may be received and stored in the system for review by a user. In order to process the main list 610 of qualitative comments from customers for useful analysis, a user may drag-and-drop the comments into bins or groups 620 of similar comments. Once several groups of similar comments are established, the system may employ a text comparison and search algorithm in which unprocessed comments in the main list 610 are searched and compared to common text in each of the respective bins or groups 620. Unprocessed comments in the main list 610 that appear to meet some predetermined threshold of similarity to one or more of the bins or groups 620 may then be presented to the user in the form of a potential match or “Possibilities” list 630. The user may then view and accept the listed “Possibilities” to batch process a plurality of similar unprocessed comments from the main list 610. The respective bins or groups 620 may also be ranked according to a ranking algorithm as described above with reference to FIG. 70, for example.

Embodiments of the invention may be implemented in the form of computer-executable instructions, such as program code or program modules, being executed by a computer or computing device. Program code or modules may include programs, objections, components, routines, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable by a single computing device.

A client device may be any type of processor-based platform that is connected to a network and that interacts with one or more application programs The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices.

Users may communicate with each other, and with other systems, networks, and devices, over the network through the respective client device. In one embodiment, the network is also coupled to a server device. Server device comprises a server executing a social network engine application or program. The social network engine allows users to participate in a social network. A social network can refer to a computer network connecting entities, such as people or organizations, by a set of social relationships, such as friendship, co-working, or information exchange, and may also refer to the computer application or data itself.

Server device may comprise a processor coupled to a computer-readable memory. Server device is in communication with at least one social network database. The server device, while discussed herein as a single computer system, may be implemented as a network of computer processors. Examples of server devices include, but are not limited to, servers, mainframe computers, networked computers, a processor-based device, and similar types of systems and devices.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. A tangible non-transitory computer-readable storage medium including computer-executable instructions stored thereon and executable by processing logic, the computer-executable instructions including modules for managing customer value creation comprising:
a data gathering and collection module including instructions for:
receiving a first dataset about a customer organization, the first dataset comprising first value attributes each having a relative numerical percentage score and a value;
processing the first dataset to generate a first quantified economic or financial impact on a profitability of the customer organization based on the first value attributes;
generating one or more customer data collection templates based on the first quantified economic or financial impact on a profitability of the customer organization for use in obtaining information from the customer organization; and
receiving a second dataset about the customer organization based on the information provided by the customer organization, the second dataset comprising second value attributes each having a relative numerical percentage score and a value; and
a data analysis module including instructions for:
processing at least the second dataset to generate a second quantified economic or financial impact on the profitability of the customer organization based on the second value attributes;
identifying one or more investment opportunities based on the second quantified economic or financial impact on the profitability of the customer organization; and
generating and prioritizing one or more initiatives to achieve the identified investment opportunities to increase the profitability of the customer organization.

2. The computer-readable medium of claim 1, wherein the processing the first dataset comprises
generating a qualitative scale having labeled increments depicting the first quantified economic or financial impact on a profitability of the customer organization based on the first value attributes.

3. The computer-readable medium of claim 2, wherein the generated one or more customer data collection templates includes the qualitative scale based on the first quantified economic or financial impact on the profitability of the customer organization for use in obtaining information from the customer organization.

4. The computer-readable medium of claim 3, wherein the receiving the second dataset about the customer organization includes input from the customer based on the qualitative scale.

5. The computer-readable medium of claim 1, wherein the receiving the second dataset about the customer organization includes receiving a ranking associated with each of the second value attributes from the customer and converting the ranking of each of the second value attributes to the relative numerical percentage score.

6. The computer-readable medium of claim 1, the data analysis module further including instructions for:
aggregating the processed second datasets from a plurality of customer organizations;
grouping similar second value attributes from the processed second datasets; and
ranking the grouped similar second value attributes based on total value.

7. The computer-readable medium of claim 6, wherein the processing at least the second dataset comprises:
providing a user interface listing unprocessed items from the aggregated second datasets from a plurality of customer organizations, which interface includes a drag-and-drop capability for the grouping of the similar second value attributes; and
utilizing search analytics to perform batch processing of the unprocessed items from the aggregated second datasets from a plurality of customer organizations.

8. The computer-readable medium of claim 1, one or more of the data gathering and collection module and analysis module further including instructions for:
providing a selectable option to allow a user to manually identify one or more investment opportunities.

9. The computer-readable medium of claim 1, the data analysis module further including instructions for:
merging the first and second datasets; and
assembling a list of the one or more generated and prioritized initiatives that have been completed.

10. A computer-implemented method for managing customer value creation, comprising:
receiving, by a computer, a first dataset about a customer organization, the first dataset comprising first value attributes each having a relative numerical percentage score and a value;
processing, by the computer, the first dataset to generate a first quantified economic or financial impact on a profitability of the customer organization based on the first value attributes;
generating, by the computer, one or more customer data collection templates based on the first quantified economic or financial impact on a profitability of the customer organization for use in obtaining information from the customer organization;
receiving, by the computer, a second dataset about the customer organization based on information provided by the customer organization, the second dataset comprising second value attributes each having a relative numerical percentage score and a value;
processing, by the computer, at least the second dataset to generate a second quantified economic or financial impact on the profitability of the customer organization based on the second value attributes;
identifying, by the computer, one or more investment opportunities based on the second quantified economic or financial impact on the profitability of the customer organization; and
generating and prioritizing, by the computer, one or more initiatives to achieve the identified investment opportunities to increase the profitability of the customer organization.

11. The computer-readable method of claim 10, wherein the processing the first dataset comprises
generating a qualitative scale having labeled increments depicting the first quantified economic or financial impact on a profitability of the customer organization based on the first value attributes.

12. The computer-readable method of claim 11, wherein the generated one or more customer data collection templates includes the qualitative scale based on the first quantified economic or financial impact on the profitability of the customer organization for use in obtaining information from the customer organization.

13. The computer-readable method of claim 12, wherein the receiving the second dataset about the customer organization includes input from the customer based on the qualitative scale.

14. The computer-readable method of claim 10, wherein the receiving the second dataset about the customer organization includes receiving a ranking associated with each of the second value attributes from the customer and converting the ranking of each of the second value attributes to the relative numerical percentage score.

15. The computer-readable method of claim 10, further comprising:
aggregating the processed second datasets from a plurality of customer organizations;
grouping similar second value attributes from the processed second datasets; and
ranking the grouped similar second value attributes based on total value.

16. The computer-readable method of claim 15, wherein the processing at least the second dataset comprises:
providing a user interface listing unprocessed items from the aggregated second datasets from a plurality of customer organizations, which interface includes a drag-and-drop capability for the grouping of the similar second value attributes; and
utilizing search analytics to perform batch processing of the unprocessed items from the aggregated second datasets from a plurality of customer organizations.

17. The computer-readable method of claim 10, further comprising:
providing a selectable option to allow a user to manually identify one or more investment opportunities.

18. The computer-readable method of claim 10, further comprising:
merging the first and second datasets; and
assembling a list of the one or more generated and prioritized initiatives that have been completed.
